(19) United States
(12) Patent Application Publication
(10) Pub. No.: US 2026/0189715 A1
(43) Pub. Date: Jul. 2, 2026

(54) METHODS AND DEVICES ON SLOPE ADJUSTMENT FOR IBC LIC AND FILTERED IBC AND FILTERED INTRA TMP AND CCCM AND GLM

(71) Applicant: BEIJING DAJIA INTERNET INFORMATION TECHNOLOGY CO., LTD., Beijing (CN)

(72) Inventors: Changyue MA, San Diego, CA (US); Xiaoyu XIU, San Diego, CA (US); Wei CHEN, San Diego, CA (US); Hong-Jheng JHU, San Diego, CA (US); Che-Wei KUO, San Diego, CA (US); Ning YAN, San Diego, CA (US); Xianglin WANG, San Diego, CA (US); Bing YU, Beijing (CN); Qi HUANG, Beijing (CN)

(73) Assignee: BEIJING DAJIA INTERNET INFORMATION TECHNOLOGY CO., LTD., Beijing (CN)

(21) Appl. No.: 19/546,255

(22) Filed: Feb. 20, 2026

Related U.S. Application Data
(63) Continuation of application No. PCT/US2024/043306, filed on Aug. 21, 2024.
(63) Continuation of application No. PCT/US2024/049276, filed on Sep. 30, 2024.
(63) Continuation of application No. PCT/US2024/061749, filed on Dec. 23, 2024.
(60) Provisional application No. 63/533,896, filed on Aug. 21, 2023.
(60) Provisional application No. 63/541,278, filed on Sep. 28, 2023.
(60) Provisional application No. 63/615,230, filed on Dec. 27, 2023.

(51) Int. Cl. H04N 19/176; H04N 19/132; H04N 19/159; H04N 19/186; H04N 19/46; H04N 19/52

(52) U.S. Cl. CPC H04N 19/176; H04N 19/132; H04N 19/159; H04N 19/186; H04N 19/46; H04N 19/52

(57) ABSTRACT

Methods and apparatus are provided for video decoding/encoding. In a method provided, a decoder may obtain an original sample value of a current block; determine a slope adjustment for a model parameter in a compensation model; and determine, based on the slope adjustment, an updated model parameter in the compensation model. The decoder may further determine based on the updated model parameter and the original sample value, a refined sample value or a second sample value of the current block.

### CROSS-REFERENCE TO RELATED APPLICATION

This application is based upon and claims priority to PCT Application No. PCT/US2024/043306, filed on Aug. 21, 2024, which claims priority to Provisional Application No. 63/533,896 filed on Aug. 21, 2023, and to PCT Application No. PCT/US2024/049276, filed on Sep. 30, 2024, which claims priority to Provisional Application No. 63/541,278 filed on Sep. 28, 2023, and to PCT Application No. PCT/US2024/061749, filed on Dec. 23, 2024, which claims priority to Provisional Application No. 63/615,230 filed on Dec. 27, 2023, all disclosures of which are incorporated herein by reference in their entirety for all purposes.

### TECHNICAL FIELD

This application is related to video coding and compression. More specifically, this disclosure relates to methods and apparatus on slope adjustment for Intra Block Copy (IBC) Local Illumination Compensation (LIC) and filtered IBC and filtered Intra Template Matching Prediction (Intra TMP) and Convolutional Cross-Component Model (CCCM) and Gradient Linear Model (GLM).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Embodiments of the present disclosure provide techniques for determining a refined sample value or a second sample value of a current block based at least in part on an updated model parameter in a compensation model and an original sample value of the current block, where the updated model parameter is determined based on a slope adjustment for a model parameter in the compensation model.

In a first aspect of the present disclosure, some embodiments of the present disclosure provide a method for video decoding including: obtaining, by a decoder, an original sample value of a current block; determining, by the decoder, a slope adjustment for a model parameter in a compensation model; determining, by the decoder and based on the slope adjustment, an updated model parameter in the compensation model; and determining, by the decoder and based on the updated model parameter and the original sample value, a refined sample value or a second sample value of the current block.

In a second aspect of the present disclosure, some embodiments of the present disclosure provide a method for video encoding including: obtaining, by an encoder, an original sample value of a current block; determining, by the encoder, a slope adjustment for a model parameter in a compensation model; determining, by the encoder and based on the slope adjustment, an updated model parameter in the compensation model; and determining, by the encoder and based on the updated model parameter and the original sample value, a refined sample value or a second sample value of the current block.

In a third aspect of the present disclosure, some embodiments of the present disclosure provide an apparatus for video decoding. The apparatus for video decoding may include one or more processors a memory coupled to the one or more processors and configured to store instructions executable by the one or more processors. Furthermore, the one or more processors, upon execution of the instructions, are configured to perform the method according to the first aspect.

In a fourth aspect of the present disclosure, some embodiments of the present disclosure provide an apparatus for video encoding. The apparatus for video encoding may include one or more processors a memory coupled to the one or more processors and configured to store instructions executable by the one or more processors. Furthermore, the one or more processors, upon execution of the instructions, are configured to perform the method according to the second aspect.

In a fifth aspect of the present disclosure, some embodiments of the present disclosure provide a non-transitory computer readable storage medium for storing computer-executable instructions that, when executed by one or more computer processors, cause the one or more computer processors to perform the method according to the first aspect.

In a sixth aspect of the present disclosure, some embodiments of the present disclosure provide a non-transitory computer readable storage medium for storing computer-executable instructions that, when executed by one or more computer processors, cause the one or more computer processors to perform the method according to the second aspect.

It is to be understood that both the foregoing general description and the following detailed description are examples only and are not restrictive of the present disclosure

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are block diagrams illustrating how a frame is recursively partitioned into multiple video blocks of different sizes and shapes in accordance with some implementations of the present disclosure.

FIG. 5 illustrates a diagram of intra modes as defined in VVC in accordance with some implementations of the present disclosure.

FIG. 6 illustrates a diagram of multiple reference lines for intra prediction in accordance with some implementations of the present disclosure.

FIGS. 7A and 7B illustrate diagrams of reference samples for Position-Dependent intra Prediction Combination (PDPC) in a top-right diagonal mode and a bottom-left diagonal mode respectively in accordance with some implementations of the present disclosure.

FIG. 8A illustrates a diagram of sub-partitions for 4×8 and 8×4 CUs in accordance with some implementations of the present disclosure.

FIG. 8B illustrates a diagram of sub-partitions for CUs other than 4×8, 8×4 and 4×4 CUs in accordance with some implementations of the present disclosure.

FIG. 9 illustrates a diagram of locations of left and above samples of a CU involved in a Cross-Component Linear Model (CCLM) prediction in accordance with some implementations of the present disclosure.

FIG. 10 illustrates a diagram of a Matrix weighted Intra Prediction (MIP) process in accordance with some implementations of the present disclosure.

FIG. 11 illustrates a diagram of spatial part of the convolutional filter in accordance with some implementations of the present disclosure.

FIG. 12 illustrates a diagram of reference area (with its paddings) used to derive the filter coefficients in accordance with some implementations of the present disclosure.

FIG. 13 illustrates a diagram of four Sobel based gradient patterns for GLM in accordance with some implementations of the present disclosure.

FIG. 14 illustrates the effect of the slope adjustment parameter “u”. Left: model created with the current CCLM. Right: model updated in accordance with some implementations of the present disclosure.

FIG. 15 illustrates intra template matching search area used in accordance with some implementations of the present disclosure.

FIG. 16 is a diagram illustrating a computing environment coupled with a user interface, according to some implementations of the present disclosure in accordance with some implementations of the present disclosure.

FIG. 17 is a flowchart illustrating a method for video decoding in accordance with some examples of the present disclosure.

FIG. 18 is a flowchart illustrating a method for video encoding in accordance with some examples of the present disclosure.

FIG. 19 is a flowchart illustrating a method for video decoding in accordance with some examples of the present disclosure.

FIG. 20 is a flowchart illustrating a method for video encoding in accordance with some examples of the present disclosure.

FIG. 21 is a flowchart illustrating a method for video decoding in accordance with some examples of the present disclosure.

FIG. 22 is a flowchart illustrating a method for video encoding in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

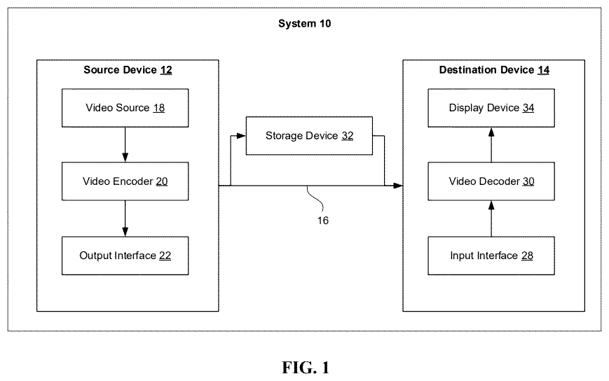

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may include any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present disclosure may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter. The encoded video data may include a sequence of pictures, each of which may include one or more sample arrays, for example, luma (Y) only for monochrome; luma and two chroma in YCbCr or YCgCo domain; or green, blue, and red in GBR (also known as RGB) domain. For convenience of notation and terminology in this application, in some embodiments, variables and terms associated with each set of three sample arrays may be referred to as luma and chroma, where the two chroma arrays may be referred to as Cb and Cr, regardless of the actual color representation method in use. The video data may be in a chroma format of 4:0:0, 4:2:0, 4:2:2, or 4:4:4, but the present application is not limited thereto.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

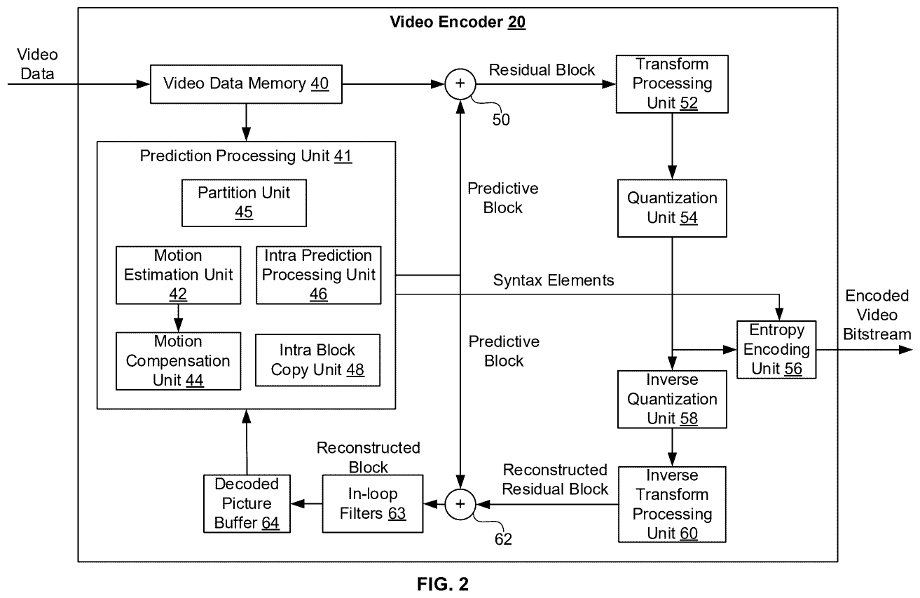

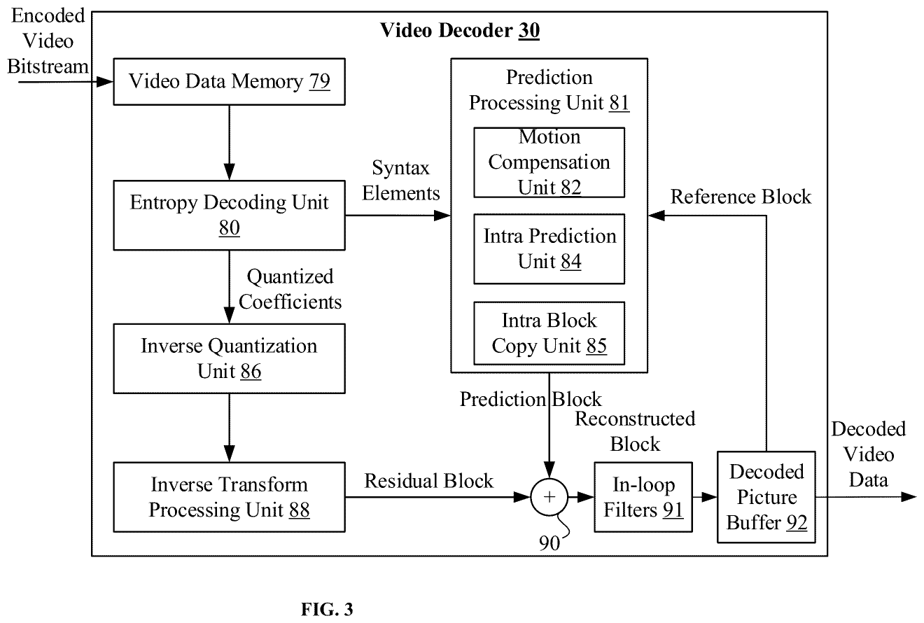

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In one or more embodiments, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component and two chroma components (which may represent Y, Cb and Cr in YCbCr domain; Y, Cg and Co in YCgCo domain; or G, B and R in RGB domain for convenience of notation and terminology in this application as described above) according to any other of the luma component and the two chroma components to modify said any component based on the selected offset. Further, it should also be illustrated that a first component mentioned herein may be any of the luma component and the two chroma components, a second component mentioned herein may be any other of the luma component and the two chroma components, and a third component mentioned herein may be a remaining one of the luma component and the two chroma components. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present disclosure. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

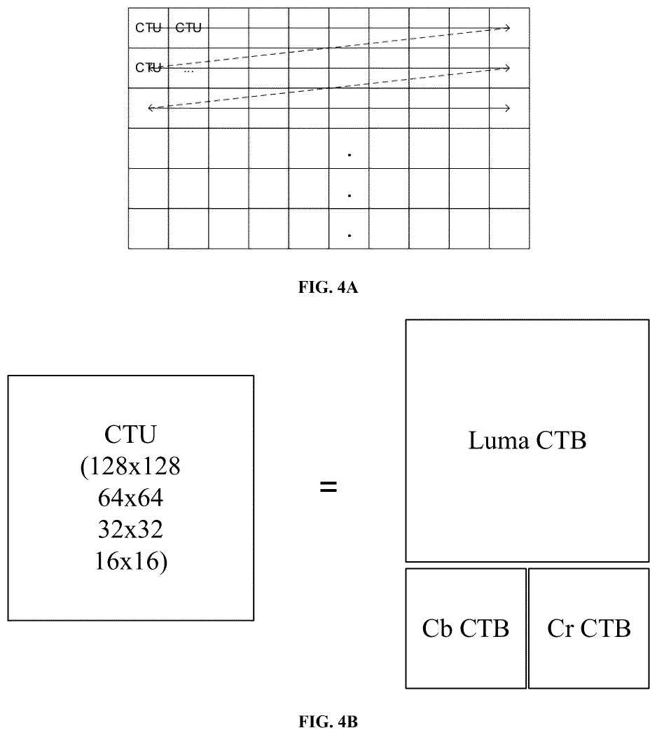

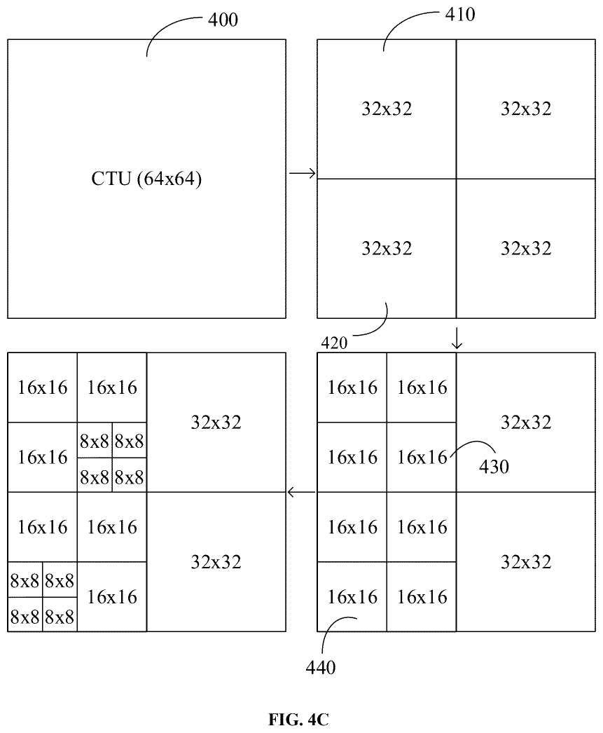

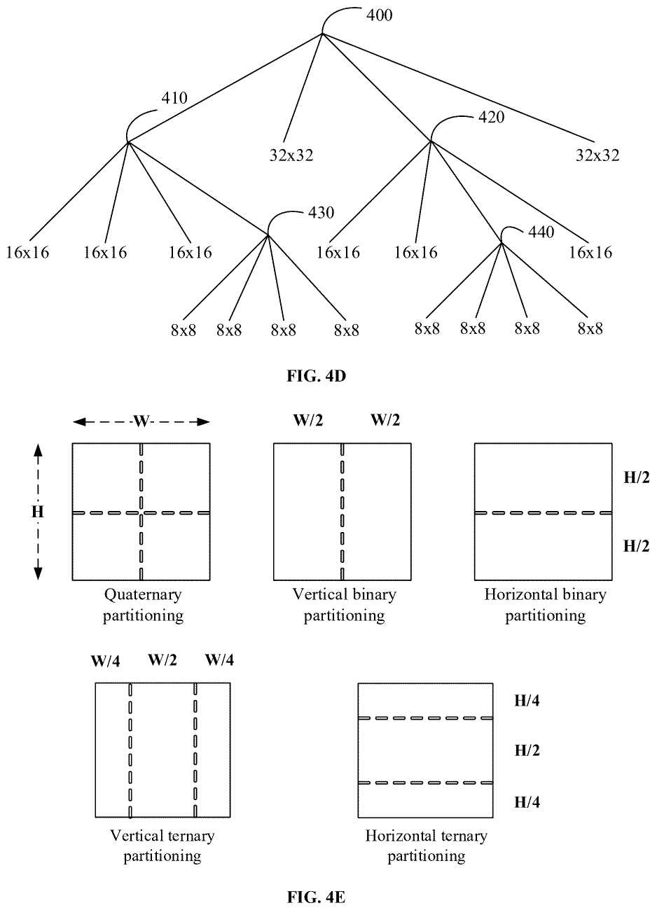

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. In the embodiments of the present disclosure, the CTU is not limited to a particular size. As shown in FIG. 4B, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more MxN PBs. A PB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

This disclosure is related to video coding and compression. More specifically, this disclosure relates to methods and apparatus for determining a refined sample value or a second sample value of a current block based at least in part on an updated model parameter in a compensation model and an original sample value of the current block, where the updated model parameter is determined based on a slope adjustment for a model parameter in the compensation model.

In general, the basic intra prediction scheme applied in VVC is almost kept the same as that of HEVC, except that several prediction tools are further extended, added and/or improved, e.g., extended intra prediction with wide-angle intra modes, Multiple Reference Line (MRL) intra prediction, PDPC, Intra Sub-Partition (ISP) prediction, CCLM prediction, and MIP.

Extended Intra Prediction with Wide-Angle Intra Modes

Like HEVC, VVC uses a set of reference samples neighboring a current CU (i.e., above the current CU or left to the current CU) to predict samples of the current CU. However, to capture finer edge directions present in natural video (especially for video content in high resolutions, e.g., 4K), a number of angular intra modes is extended from 33 in HEVC to 93 in VVC. FIG. 5 illustrates a diagram of intra modes as defined in VVC. As shown in FIG. 5, among the 93 angular intra modes, modes 2 to 66 are conventional angular intra modes, and modes −1 to −14 and modes 67 to 80 are wide-angle intra modes. In addition to the angular intra modes, the planar mode (mode 0 in FIG. 5) and Direct Current (DC) mode (mode 1 in FIG. 5) of HEVC are also applied in VVC.

Since a quad/binary/ternary tree partition structure is applied in VVC, besides video blocks in square shape, rectangular video blocks also exist for the intra prediction in VVC. Due to unequal width and height of one given video block, various sets of angular intra modes may be selected from the 93 angular intra modes for different block shapes. More specifically, for both square and rectangular video blocks, besides planar and DC modes, 65 angular intra modes among the 93 angular intra modes are also supported for each block shape. When a rectangular block shape of a video block satisfies a certain condition, an index of a wide-angle intra mode of the video block may be adaptively determined by the video decoder 30 according to an index of a conventional angular intra mode received from the video encoder 20 using a mapping relationship as shown in Table 1 below. That is, for non-square blocks, the wide-angle intra modes are signaled by the video encoder 20 using the indexes of the conventional angular intra modes, which are mapped to indexes of the wide-angle intra modes by the video decoder 30 after being parsed, thus ensuring that a total number (i.e., 67) of intra modes (i.e., the planar mode, the DC mode and 65 angular intra modes among the 93 angular intra modes) is unchanged, and the intra mode coding method is unchanged. As a result, a good efficiency of signaling intra modes is achieved while providing a consistent design across different block sizes.

Table 1 shows a mapping relationship between indexes of conventional angular intra modes and indexes of wide-angle intra modes for the intra prediction of different block shapes in VCC, wherein W represents a width of a video block, and H represents a height of the video block.

TABLE 1

| Block | Aspect | Indexes of conventional angular | Indexes of wide-angle |
|---|---|---|---|
| shape | ratio | intra modes | intra modes |
| Square, | W/H == 1 | None | None |
| W = H | | | |
| Flat rectangle, | W/H == 2 | 2, 3, 4, 5, 6, 7, 8, 9 | 67, 68, 69, 70, 71, 72, |
| W > H | | | 73, 74 |
| | W/H == 4 | 2, 3, 4, 5, 6, 7, 8, 9, 10, 11 | 67, 68, 69, 70, 71, 72, |
| | | | 73, 74, 75, 76 |
| | W/H == 8 | 2, 3, 4, 5, 6, 7, 8, 9, 10, 11, 12, 13 | 67, 68, 69, 70, 71, 72, |
| | | | 73, 74, 75, 76, 77, 78 |
| | W/H == | 2, 3, 4, 5, 6, 7, 8, 9, 10, 11, 12, 13, 14, 15 | 67, 68, 69, 70, 71, 72, |
| | 16 | | 73, 74, 75, 76, 77, 78, |
| | | | 79, 80 |
| Tall rectangle, | W/H == | 59, 60, 61, 62, 63, 64, 65, 66 | −8, −7, −6, −5, −4, −3, |
| W < H | ½ | | −2, −1 |
| | W/H == | 57, 58, 59, 60, 61, 62, 63, 64, 65, 66 | −10, −9, −8, −7, −6, −5, −4, |
| | ¼ | | −3, −2, −1 |
| | W/H == | 55, 56, 57, 58, 59, 60, | −12, −11, −10, −9, −8, −7, |
| | ⅛ | 61, 62, 63, 64, 65, 66 | −6, −5, −4, −3, −2, −1 |
| | W/H == | 53, 54, 55, 56, 57, 58, 59, | −14, −13, −12, −11, −10, |
| | 1/16 | 60, 61, 62, 63, 64, 65, 66 | −9, −8, −7, −6, −5, −4, −3, |
| | | | −2, −1 |

### MRL Intra Prediction

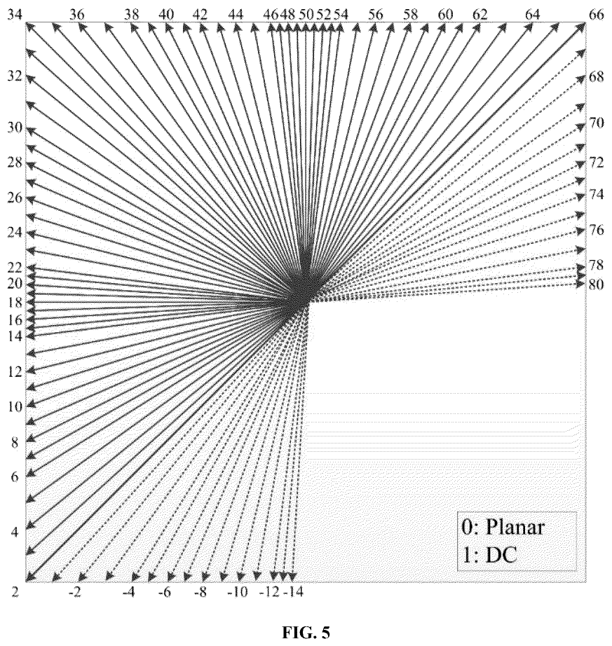

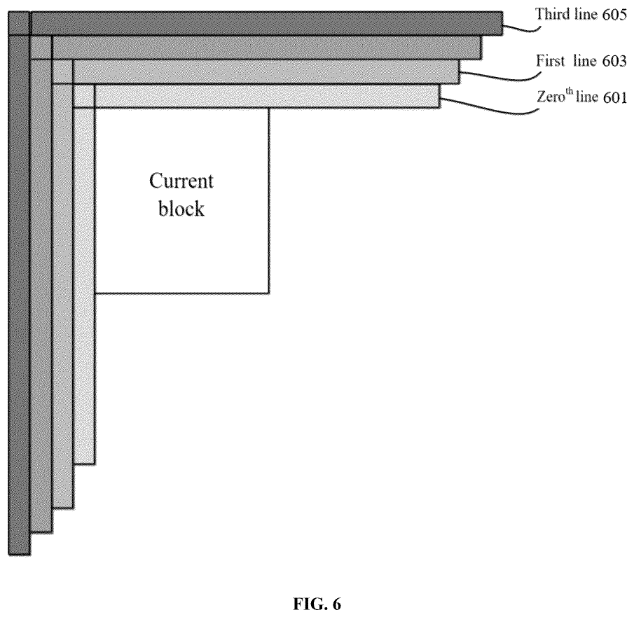

Similarly to the intra prediction in HEVC, all the intra modes (i.e., planar, DC and angular intra modes) in VVC utilize a set of reference samples above and left to a current video block for intra prediction. However, differently from HEVC where only the nearest row/column (i.e., a zeroth line 601 in FIG. 6) of reference samples are used, MRL intra prediction is introduced in VVC where in addition to the nearest row/column of reference samples, two additional rows/columns of reference samples (i.e., a first line 603 and a third line 605 in FIG. 6) may be used for the intra prediction. An index of a selected row/column of reference samples is signaled from the video encoder 20 to the video decoder 30. When a non-nearest row/column of reference samples (i.e., the first line 603 or the third line 605 in FIG. 6) is selected, the planar mode is excluded from a set of intra modes that may be used to predict the current video block. The MRL intra prediction is disabled for a first row/column of video blocks inside a current CTU to prevent using extended reference samples outside the current CTU.

### PDPC

As mentioned earlier, the intra prediction samples are generated from a set of neighboring reference samples, which may introduce discontinuities along block boundaries between a current video block and neighboring video blocks thereof. The PDPC tool is introduced in VVC to solve such problems by employing a weighted combination of intra prediction samples with boundary reference samples. In VVC, PDPC may be enabled for the following intra modes without signaling: planar mode, DC mode, angular intra modes with indexes less than or equal to that of a horizontal intra mode (i.e., mode 18), and angular intra modes with indexes greater than or equal to that of a vertical intra mode (i.e., mode 50) and less than or equal to 80. If a Block Differential Pulse Coded Modulation (BDPCM) mode is applied for the current block or an index of a selected row/column of reference samples for MRL intra prediction is greater than 0, PDPC is not applied. Assuming that a prediction sample of a current sample located at coordinate (x, y) is pred (x,y), a modified prediction sample pred′(x,y) after the PDPC is performed is calculated as:

$$pred ’ ( x , y ) = Clip 3 ( 0 , ( 1 ≪ BitDepth ) - 1 , ( wL \times {R}_{- 1 , y ’} + wT \times {R}_{x ’ , - 1} + ( 64 - wL - wT ) \times pred ( x , y ) + 32 ) ≫ 6 ) \qquad ( 1 )$$

where Bitdepth represents a bit depth of samples, R_{x′, -1} and R_{-1,y′} represent reference samples located at top and left boundaries of the current sample, respectively, wL and wT are weights which are adaptively selected according to an intra mode and a block size of the current block, “>>” represents a bitwise right shift operation, and “<<” indicates a bitwise left shift operation.

The function Clip3 (x, y, z) in the equation (1) may be defined as follows:

$$Clip 3 ( x , y , z ) = \{ \begin{matrix}x & z < x \\ y & z > y \\ z & otherwise\end{matrix} \qquad ( 2 )$$

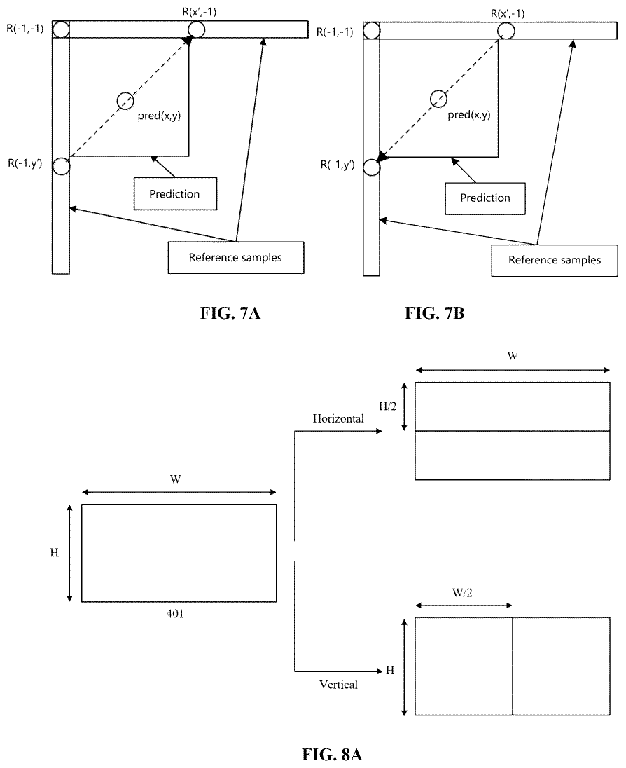

FIGS. 7A and 7B illustrate diagrams of reference samples for PDPC in a top-right diagonal mode and a bottom-left diagonal mode respectively. The prediction sample pred (x,y) is located at (x,y) in the prediction block. The reference sample R_{x′, -1} has a horizontal coordinate of x′=x+y+1 and a vertical coordinate of −1, and the reference sample R_{-1,y′} has a horizontal coordinate of −1 and a vertical coordinate of y′=x+y+1.

### ISP Prediction

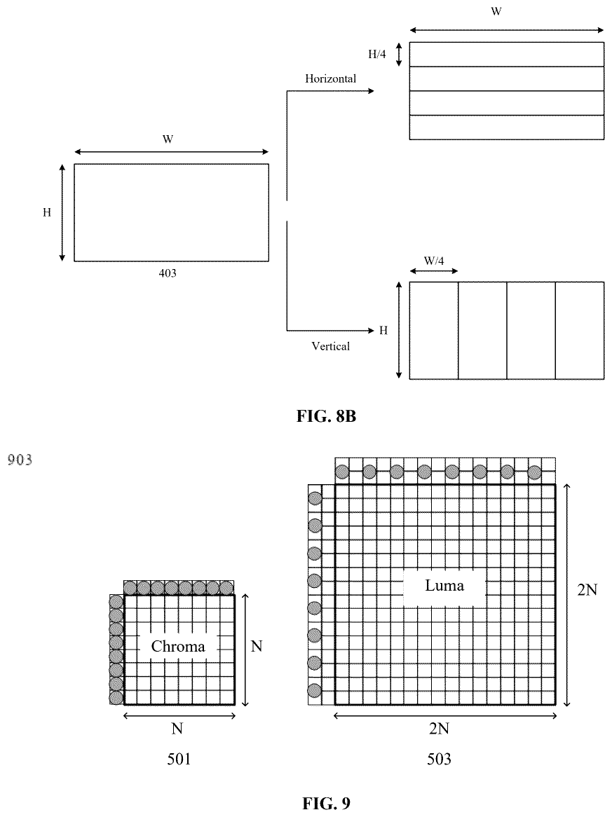

The ISP prediction is a tool applied for luma intra prediction modes, which divides luma video blocks vertically or horizontally into 2 or 4 sub-partitions depending on block sizes thereof, as shown in Table 2. For example, a minimum block size for ISP is 4×8 or 8×4. FIGS. 8A and 8B show diagrams of sub-partitions depending on a block size. If a block size W×H of a video block (for example, the video block 401 as shown in FIG. 8A) is equal to 4×8 or 8×4, then the video block is divided into 2 sub-partitions. If a block size W×H of a video block (for example, the video block 403 as shown in FIG. 8B) is greater than 4×8 or 8×4, then the video block is divided into 4 sub-partitions. A CU size that may use ISP is restricted to a maximum of 64×64. All sub-partitions fulfill a condition of having at least 16 samples.

TABLE 2

| Block size | Number of sub-partitions |
|---|---|
| 4 × 4 | Not divided |
| 4 × 8 and 8 × 4 | 2 |
| All other feasible cases | 4 |

For each sub-partition, reconstructed samples are obtained by adding a residual signal to a prediction signal. Here, the residual signal is generated by processes such as entropy decoding, inverse quantization and inverse transform. The reconstructed samples of each sub-partition are available to generate prediction of a next sub-partition. In addition, a first sub-partition to be processed is the one containing a top-left sample of the CU, and after the first sub-partition is processed, the ISP prediction continues downwards (for horizontal splitting as shown in FIGS. 8A and 8B) or rightwards (for vertical splitting as shown in FIGS. 8A and 8B). All sub-partitions share the same intra prediction mode.

### CCLM Prediction

To reduce the cross-component redundancy, a CCLM prediction mode is used in VVC, wherein chroma samples of a CU are predicted based on reconstructed luma samples rec_L (i,j) of the CU by using a linear model as follows:

$${pred}_{c} ( i , j ) = α \cdot {rec}_{L}^{′} ( i , j ) + β \qquad ( 3 )$$

where pred_{C}(i, j) represents predicted chroma samples in the CU, rec_{L′}(i, j) represents down-sampled reconstructed luma samples of the CU which are obtained by performing down-sampling on the reconstructed luma samples rec_{L}(i, j), and α and β are linear model parameters which are derived from at most four neighbouring chroma samples and their corresponding down-sampled luma samples. Suppose that a current chroma block has a size of W×H, then W′ and H′ are obtained as follows:
W′=W, H′=H when an LM mode is applied;
W′=W+H when an LM_A mode is applied;
H′=H+W when an LM_L mode is applied.
where in the LM mode, above samples and left samples of the CU are used together to calculate the linear model coefficients; in the LM_A mode, only the above samples of the CU are used to calculate the linear model coefficients; and in the LM_L mode, only the left samples of the CU are used to calculate the linear model coefficients.

If locations of above samples of a chroma block are denoted as S[0, −1] . . . S[W′−1, −1] and locations of left samples of the chroma block are denoted as S[−1, 0] . . . S[−1, H′−1], positions of four neighbouring chroma samples are selected as follows:
S[W′/4, −1], S[3*W′/4, −1], S[−1, H′/4] and S[−1, 3*H′/4] are selected as the positions of the four neighbouring chroma samples when the LM mode is applied and both of the above and left samples are available;
S[W′/8, −1], S[3*W′/8, −1], S[5*W′/8, −1] and S[7*W′/8, −1] are selected as the positions of the four neighbouring chroma samples when the LM_A mode is applied and the above samples are available or when only the above samples are available;
S[−1, H′/8], S[−1, 3*H′/8], S[−1, 5*H′/8] and S[−1, 7*H′/8] are selected as the positions of the four neighbouring chroma samples when the LM_L mode is applied and the left samples are available or when only the left samples are available.

Four neighbouring luma samples corresponding to the selected locations are obtained by a down-sampling operation and the obtained four neighbouring luma samples are compared four times to find two larger values: x⁰_{A} and x¹_{A} and two smaller values: x⁰_{B} and x¹_{B}. Chroma sample values corresponding to the two larger values and the two smaller values are denoted as y⁰_{A}, y¹_{A}, y⁰_{B} and y¹_{B} respectively. Then Xₐ, X_{b}, Yₐ and Y_{b} are derived as:

$$\begin{matrix}{X}_{a} = ( {x}_{A}^{0} + {x}_{A}^{1} + 1 ) ≫ 1 ; \\ {X}_{b} = ( {x}_{B}^{0} + {x}_{B}^{1} + 1 ) ≫ 1 ; \\ {Y}_{a} = ( {y}_{A}^{0} + {y}_{A}^{1} + 1 ) ≫ 1 ; \\ {Y}_{b} = ( {y}_{B}^{0} + {y}_{B}^{1} + 1 ) ≫ 1.\end{matrix} \qquad ( 4 )$$

Finally, the linear model parameters α and β are obtained according to the following equations.

$$\begin{matrix}α = \frac{{Y}_{a} - {Y}_{b}}{{x}_{a} - {x}_{b}} \\ β = {Y}_{b} - α \cdot {X}_{b}\end{matrix} \qquad ( 5 )$$

FIG. 9 shows a diagram of locations of left and above samples of the CU involved in the CCLM mode, including locations of left and above samples of an N×N chroma block 901 in the CU and locations of left and above samples of an 2N×2N luma block 903 in the CU.

The parameter computation described above is performed as part of the decoding process, and therefore no syntax element is used to convey values of α and β from the video encoder 20 to the video decoder 30.

### MIP

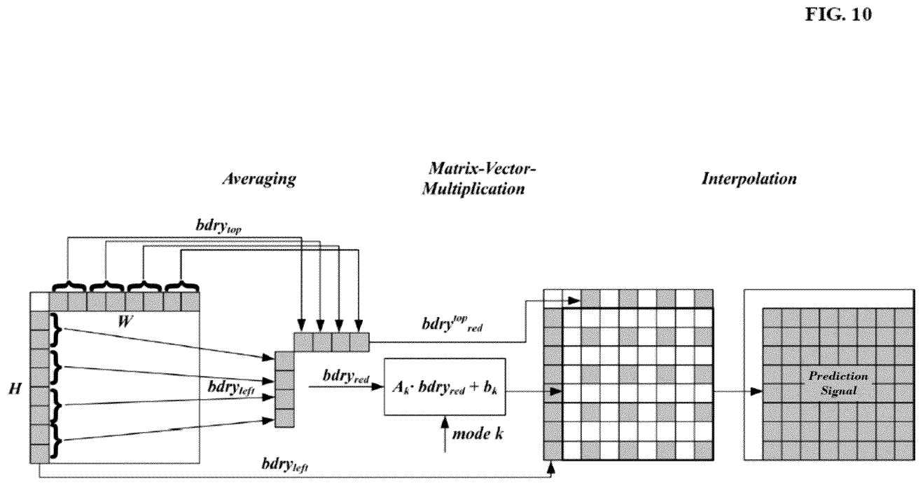

MIP is an intra prediction method newly added into VVC. In the MIP prediction method, a prediction signal of samples of a rectangular block of width W and height H is generated by taking one column of H reconstructed neighbouring boundary samples left to the rectangular block and one row of W reconstructed neighbouring boundary samples above the rectangular block as input based on the following three steps, which are averaging, matrix vector multiplication and linear interpolation as shown in FIG. 10.

### First Step: Averaging Neighboring Samples

Four samples or eight samples are determined by averaging the neighboring boundary samples bdryₜₒₚ and bdry_{left} based on block size and shape. Specifically, the neighboring boundary samples bdryₜₒₚ and bdry_{left} are reduced to boundary samples

$${bdry}_{red}^{top}$$

and

$${bdry}_{red}^{left}$$

by averaging the neighboring boundary samples bdryₜₒₚ and bdry_{left} according to a predefined rule depending on the block size. Then, the reduced boundary samples

$${bdry}_{red}^{top}$$

and

$${bdry}_{red}^{left}$$

are concatenated to a reduced boundary vector bdry_{red} which thus has a size of 4 for blocks of shape 4×4 and has a size of 8 for blocks of all other shapes. If Index_{mode} refers to the MIP-mode, this concatenation is defined as follows:

$${bdry}_{red} = \{ \begin{matrix}[ {bdry}_{red}^{top} , {bdry}_{red}^{left} ] & for W = H = 4 and {Index}_{mode} < 18 \\ [ {bdry}_{red}^{left} , {bdry}_{red}^{top} ] & for W = H = 4 and {Index}_{mode} \geq 18 \\ [ {bdry}_{red}^{top} , {bdry}_{red}^{left} ] & for max ( W , H ) = 8 and {Index}_{mode} < 10 \\ [ {bdry}_{red}^{left} , {bdry}_{red}^{top} ] & for max ( W , H ) = 8 and {Index}_{mode} \geq 10 \\ [ {bdry}_{red}^{top} , {bdry}_{red}^{left} ] & for max ( W , H ) > 8 and {Index}_{mode} < 6 \\ [ {bdry}_{red}^{left} , {bdry}_{red}^{top} ] & for max ( W , H ) > 8 and {Index}_{mode} \geq 6.\end{matrix} \qquad ( 6 )$$

### Second Step: Matrix Vector Multiplication

A matrix vector multiplication, followed by addition of an offset, is carried out with the averaged samples in the reduced boundary vector bdry_{red} as an input, to generate a reduced prediction signal of a down-sampled set of samples in the original block. More specifically, the reduced prediction signal pred_{red} is computed as:

$${pred}_{red} = A \cdot {bdry}_{red} + b \qquad ( 7 )$$

Here, A is a matrix that has W_{red}·H_{red} rows and 4 columns if W=H=4 or 8 columns in all other cases. b is an offset vector of size W_{red}. H_{red}.

Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 8 )$$

$${H}_{red} = \{ \begin{matrix}4 & for max ( W , H ) \leq 8 \\ min ( H , 8 ) & for max ( W , H ) > 8\end{matrix} \qquad ( 9 )$$

The matrix A and the offset vector b are taken from one of the sets S₀, S₁, S₂. An index idx of a set from which the matrix A and the offset vector b are taken is defined as follows:

$$idx = \{ \begin{matrix}0 & for W = H = 4 \\ 1 & for max ( W , H ) = 8 \\ 2 & for max ( W , H ) > 8\end{matrix} \qquad ( 10 )$$

Here, each coefficient of the matrix A is represented with 8-bit precision. The set S₀ consists of 16 matrices

$${A}_{0}^{i}$$

each or which has 10 rows and 4 columns and 16 offset vectors

$${b}_{0}^{i}$$

each of size 16, i∈{0, . . . , 115}. Matrices and offset vectors of that set are used for blocks of size 4×4. The set S₁ consists of 8 matrices

$${A}_{1}^{i}$$

each of which has 16 rows and 8 columns 8 offset vectors

$${b}_{1}^{i}$$

each of size 16, i∈{0, . . . , 7}. The set S₂ consists of 6 matrices

$${A}_{2}^{i}$$

each of which has 64 rows and 8 columns and of 6 offset vectors

$${b}_{2}^{i}$$

of size 64, i∈{0, . . . , 5}.

### Third Step: Interpolation

The prediction signal at the remaining positions is generated from the reduced prediction signal of the down-sampled set of samples by linear interpolation which is a single step linear interpolation in each direction. The interpolation is performed firstly in the horizontal direction and then in the vertical direction regardless of block shape or block size.

### Intra Block Copy

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:

IBC skip/merge mode: a merge candidate index is used to indicate which of the block vectors in the list from neighboring candidate IBC coded blocks is used to predict the current block. The merge list includes spatial, HMVP, and pairwise candidates.

IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### Convolutional Cross-Component Model (CCCM) for Intra Prediction

In this method, convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 11.

The nonlinear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChroma Val = {c}_{0} C + {c}_{1} N + {c}_{2} S + {c}_{3} E + {c}_{4} W + {c}_{5} P + {c}_{6} B$$

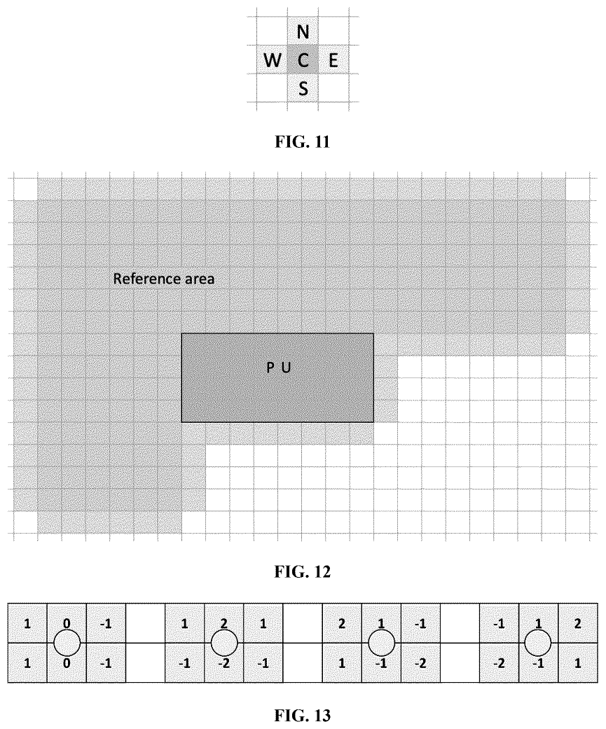

The filter coefficients ci are calculated by minimising MSE between predicted and reconstructed chroma samples in the reference area. FIG. 12 illustrates the reference area which consists of 2 or 6 lines of chroma samples above and left of the PU. Whether to use 6 lines or 2 lines of neighbouring samples to derive the CCCM model parameters in the single model CCCM is determined by a template cost. Similarly, for the multi-model CCCM mode, the two candidates use 6 lines neighbouring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. In some embodiments of the present disclosure, fixed offsets may be removed from luma and chroma samples in each PU for each model. This is driving down the magnitudes of the values used in the model creation and allows reducing the precision needed for the fixed-point arithmetic. As a result, 16-bit decimal precision is provided to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$$\begin{matrix}{C}^{′} = C - offsetLuma \\ {N}^{′} = N - offsetLuma \\ {S}^{′} = S - offsetLuma \\ {E}^{'} = E - offsetLuma \\ {W}^{′} = W - offsetLuma \\ {P}^{′} = nonLinear ( {C}^{′} ) \\ B = midValue = 1 ≪ ( bitDepth - 1 )\end{matrix}$$

and the chroma value is predicted using the following equation, where offsetChroma is equal to offsetCr and offsetCb for Cr and Cb components, respectively:

$$predChromaVal = c 0 {C}^{′} + c 1 {N}^{′} + c 2 {S}^{′} + c 3 {E}^{′} + c 4 {W}^{′} + c 5 {P}^{′} + c 6 B + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$predChromaVal = c 0 {C}^{′} + c 1 {N}^{′} + c 2 {S}^{′} + c 3 {E}^{′} + c 4 {W}^{′} + c 5 {P}^{′} + c 6 B + offsetChroma$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation, as illustrated in FIG. 13.

### Multi-model LM (MMLM)

CCLM included in VVC is extended by adding three Multi-model LM (MMLM) modes (JVET-D0110). In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment is applied to cross-component linear model (CCLM) and to Multi-model LM prediction. The adjustment is tilting the linear function which maps luma values to chroma values with respect to a center point determined by the average luma value of the reference samples.

### Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$\begin{matrix}chromaVal = a ’ * lumaVal + b ’ \\ where \\ a ’ = a + u \\ b ’ = b - u * {y}_{r} .\end{matrix}$$

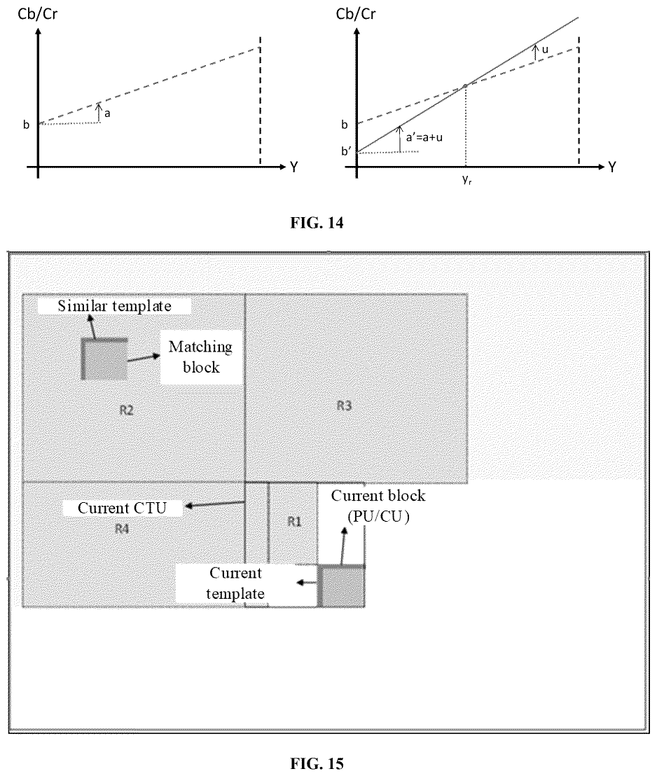

With this selection the mapping function is tilted or rotated around the point with luminance value yᵣ. The average of the reference luma samples used in the model creation as yᵣ in order to provide a meaningful modification to the model. FIG. 14 illustrates the process.

### Implementation

Slope adjustment parameter is provided as an integer between −4 and 4, inclusive, and signaled in the bitstream. The unit of the slope adjustment parameter is ⅛th of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The provided encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped, Top-only or Left-Only causal neighbor of the current block with another block in a predefined search area in FIG. 15 consisting of:
R1: current CTU
R2: top-left CTU
R3: above CTU
R4: left CTU

Sum of absolute differences (SAD) is used as a cost function.

Within each region, the decoder constructs a candidate list of up to “19” template matching block vectors that are ranked in ascending order according to the template cost (SAD). The following modes are supported:

Single predictor: A single predictor is selected from the candidate list.

Fusion of multiple predictors: multiple predictors are blended multiple to derive the final prediction block. The blending weights are either computed from the template matching cost of each predictor, or with Wiener-filter based weight derivation method.

Sub-pel precision: When signle predictor is used, sub-pel precion can be used with ½-pel precision, ¼-pel precision and ¾-pel precision, each with 8 possible directions

Linear filter model: A linear filter can be learned between the reference template and current template and be applied the linear model to reference block. This mode can be used for single predictor when sub-pel precision is not used.

In this method, a linear model is derived between the reference and current templates, the derived model is applied to the IntraTMP predictor. Similar to CCCM, a model is represented by 6-tap filter consisting of a 5-tap spatial and a bias terms.

$$predLumaVal = c 0 C + c 1 N + c 2 S + c 3 E + c 4 W + c 5 * ( 1 ≪ ( bitdepth - 1 ) )$$

The template size is 4, and the method is applied to the best BV candidate. A flag is signalled to indicate the mode usage.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = min ( 64 , a * BlkW ) \\ SearchRange\_h = min ( 64 , a * BlkH )\end{matrix}$$

Where ‘a’ is a constant that controls the gain/complexity trade-off. In practice, ‘a’ is equal to 5.

To speed-up the template matching process, the search range of all search regions is subsampled by a factor of 3. After finding the best match, a refinement process is performed. The refinement is done via a second template matching search around the best match with a reduced range.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### Local Illumination Compensation (LIC)

LIC is an inter prediction technique to model local illumination variation between current block and its prediction block as a function of that between current block template and reference block template. The parameters of the function can be denoted by a scale a and an offset β, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on current block template and reference block template, no signaling overhead is required for them, except that an LIC flag is signaled for AMVP mode to indicate the use of LIC.

The local illumination compensation proposed in JVET-00066 is used for uni-prediction inter CUs with the following modifications.

Intra neighbor samples can be used in LIC parameter derivation;

LIC is disabled for blocks with less than 32 luma samples;

For both non-subblock and affine modes, LIC parameter derivation is performed based on the template block samples corresponding to the current CU, instead of partial template block samples corresponding to first top-left 16×16 unit;

Samples of the reference block template are generated by using MC with the block MV without rounding it to integer-pel precision.

IBC with Local Illumination Compensation

Intra block copy with local illumination compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

### IBC LIC Extension

IBC-LIC is extended by including 3 additional modes:

Use only left or use only above LIC template in addition to the current L-shape template.

Extend the MMLM to IBC-LIC, which allows IBC-LIC to have two linear models in one CU for L-shape template.

### Filtered IBC

In this method, additional filtered IBC mode is introduced, where a filter is applied to IBC predictor, which is derived by minimizing MSE between current and reference template.

Output of the filter is calculated as follows:

$$predLumaVal = c 0 C + c 1 N + c 2 S + c 3 E + c 4 W + c 5 P + c 6 B$$

The nonlinear term P is represented as power of two of the center sample C and scaled to the sample value range of the content:

$$P = ( C * C + midVal ) ≫ bitDepth$$

The bias term B represents a scalar offset between the input and output and is set to middle luma value (512 for 10-bit content).

This filtered mode is used as an additional mode for non-merge IBC blocks, and it is not used together with IBC-LIC, IBC-CIIP or RR-IBC. For IBC merge modes, this filtering mode is inherited when merge mode list is constructed.

### Slope Adjustment for LIC

In some embodiments of the present disclosure, a method of local illumination compensation with slope adjustment is provided, in which an adjustment parameter is used to update the LIC parameters similar to the slope adjustment of CCLM. The adjustment parameter is signalled for AMVP mode.

### Problem Statement

Currently, the linear parameters of IBC LIC are obtained from the template, which may have the overfitting problem when applying the obtained linear model to current block. Similar to slope adjustment for CCLM and LIC, it is straightforward to apply slope adjustment to IBC LIC, which may further improve the coding performance.

Currently, the convolution parameters of Filtered IBC are obtained from the template, which may have the overfitting problem when applied the obtained convolution model to current block. Similar to slope adjustment for CCLM and LIC, it is straightforward to apply slope adjustment to Filtered IBC, which may further improve the coding performance.

Currently, the convolution parameters of Filtered Intra TMP are obtained from the template, which may have the overfitting problem when applied the obtained convolution model to current block. Similar to slope adjustment for CCLM and LIC, it is straightforward to apply slope adjustment to Filtered Intra TMP, which may further improve the coding performance.

Currently, the convolution parameters of CCCM are obtained from the template, which may have the overfitting problem when applied the obtained convolution model to current block. Similar to slope adjustment for CCLM and LIC, it is straightforward to apply slope adjustment to CCCM, which may further improve the coding performance.

Currently, the linear parameters of GLM are obtained from the template, which may have the overfitting problem when applied the obtained linear model to current block. Similar to slope adjustment for CCLM and LIC, it is straightforward to apply slope adjustment to GLM, which may further improve the coding performance.

### Proposed Methods

In this disclosure, to address the issues as pointed out in the “problem statement” section, methods are provided to further improve the existing design of IBC LIC, Filtered IBC, Filtered Intra TMP, CCCM and GLM. In general, the main features of the provided technologies in this disclosure are summarized as follows.

The slope adjustment method is applied to IBC LIC, where an adjustment parameter is used to update the IBC LIC linear parameters.

The slope adjustment method is applied to Filtered IBC, where one or more adjustment parameters are used to update the Filtered IBC convolution parameters.

The slope adjustment method is applied to Filtered Intra TMP, where one or more adjustment parameters are used to update the Filtered Intra TMP convolution parameters.

The slope adjustment method is applied to CCCM, where one or more adjustment parameters are used to update the CCCM convolution parameters.

The slope adjustment method is applied to GLM, where one or more adjustment parameters are used to update the GLM linear parameters.

In some embodiments of the present disclosure, the disclosed methods may be applied independently or jointly.

### Slope Adjustment for IBC LIC

According to one or more embodiments of the disclosure, slope adjustment is applied to IBC LIC. Different methods may be used to achieve this goal.

Generally, IBC LIC uses a linear model with 2 parameters to compensate the illumination variation between the prediction block and current block. The slope parameter “a” and the bias parameter “b” define the mapping as follows:

$${Pred}_{illu} = a * {Pred}_{ori} + b$$

where Predₒᵣᵢ and Predᵢₗₗᵤ represent the original prediction block and the refined prediction block with illumination compensation. The values of slope parameter “a” and the bias parameter “b” are obtained according to the template of current block and the reference samples of the template of current block as described in the background.

When applying slope adjustment to IBC LIC, an adjustment “u” to the slope parameter is utilized to update the model to the following form:

$$\begin{matrix}{Pred}_{illu} = a ’ * {Pred}_{ori} + b ’ \\ where \\ a ’ = a + u \\ b ’ = b - u * {y}_{r} .\end{matrix}$$

With this selection, the mapping function is tilted or rotated around the point with sample value yᵣ, where yᵣ is equal to the average value of the template reference samples used in the model creation. Similar to slope adjustment for CCLM and LIC, y, is imported in order to provide a meaningful modification to the model.

The slope adjustment parameter may be in different range. In some examples, the range of the slope adjustment parameter is between −n to n, where n is an integer. For example, same to slope adjustment for CCLM, the slope adjustment parameter is provided as an integer between −4 and 4, inclusive. In another example, the slope adjustment parameter is provided as an integer between −3 and 3, inclusive. The slope adjustment parameter may be defined in different granularities. In some examples, the granularity of the slope adjustment is 1/x^{th} of the refined sample value of the prediction block, where x is an integer. The granularity refers to the smallest possible adjustment that can be made, and it is typically defined as a fraction of the refined sample value of the prediction block. For example, same to slope adjustment for CCLM, the unit of the slope adjustment parameter is ⅛^{th} of the sample value of the refined prediction block with illumination compensation per one sample value of the original prediction block (for 10-bit content). In another example, the unit of the slope adjustment parameter is 1/16th of the sample value of the refined prediction block with illumination compensation per one sample value of the original prediction block (for 10-bit content). After defining the range and granularity of the slope adjustment parameter, the specific slope adjustment offset can be defined in different methods. In the first method, the specific slope adjustment offset is equally distributed in the range. For example, When the slope adjustment parameter is provided as an integer between −4 and 4, inclusive ({−4, −3, −2, −1, 1, 2, 3, 4}), and the unit of the slope adjustment parameter is ⅛th of the sample value of the refined prediction block with illumination compensation per one sample value of the original prediction block (for 10-bit content), then the corresponding specific slope adjustment offset is {−½, −⅜, −¼, −⅛, ⅛, ¼, ⅜, ½}. This means that for each integer value of the slope adjustment parameter, the offset is equally distributed across the range, with each increment being a fraction of the refined sample value. In the second method, the specific slope adjustment offset is unequally distributed in the range. In this method, the offsets are typically symmetric around zero but may follow different patterns. For example, one pattern is to increase the magnitude of the offsets symmetrically as the slope adjustment parameter moves away from zero, following powers of two. For example, when the slope adjustment parameter is provided as an integer between −4 and 4, inclusive ({−4, −3, −2, −1, 1, 2, 3, 4}), and the unit of the slope adjustment parameter is 1/16th of the sample value of the refined prediction block with illumination compensation per one sample value of the original prediction block (for 10-bit content), then the corresponding specific slope adjustment offset is {−½, −¼, −⅛, − 1/16, 1/16, ⅛, ¼, ½}. In this case, the adjustment offsets are symmetrically distributed, with the magnitude of the offset increasing as powers of two away from zero, ensuring finer adjustments closer to zero and larger adjustments at the extremes of the range. This method provides a more granular control over the adjustment, particularly when fine-tuning the prediction block is critical. In summary, the slope adjustment parameter can vary in both its range and granularity, allowing for different levels of precision in adjusting the prediction block values. The specific slope adjustment offsets can be determined either by equal distribution within the range or by a more nuanced, uneven distribution, typically following a symmetric pattern that decreases in magnitude. These methods allow flexibility in defining how slope adjustments are applied to the prediction blocks based on the system's needs and the desired level of precision.

The IBC LIC model may include different modes and slope adjustment may be applied to different IBC LIC modes. In one example, slope adjustment may be applied to an IBC LIC model with a single-model IBC LIC mode with the L-shape template and an IBC LIC model with multi-model IBC LIC mode with the L-shape template. In another example, slope adjustment is applied to all IBC-LIC modes, which include single-model IBC LIC mode with L-shape template, single-model IBC LIC mode with only left template, single-model IBC LIC mode with only above template, and multi-model IBC LIC mode with the L-shape template. When slope adjustment is applied for a multi-model IBC LIC mode with the L-shape template, both IBC LIC models can be adjusted and yᵣ can be computed for the two IBC LIC models separately, where yᵣ for the first model is equal to the average value of the template reference samples used in the first IBC LIC model creation, yᵣ for the second model is equal to the average value of the template reference samples used in the second IBC LIC model creation. In a third example, slope adjustment is applied to IBC LIC single models, which include IBC LIC mode with L-shape template, IBC LIC mode with only left template, and IBC LIC mode with only above template.

The slope adjustment may be applied to different IBC LIC modes. In one example, slope adjustment is applied to IBC LIC mode with the L-shape template and multi-model IBC LIC mode with the L-shape template. In another example, slope adjustment is applied to all IBC-LIC modes, which include IBC LIC mode with L-shape template, IBC LIC mode with only left template, IBC LIC mode with only above template, and multi-model IBC LIC mode with the L-shape template. When slope adjustment is applied for a multi-model IBC LIC mode with the L-shape template, both IBC LIC models can be adjusted and yᵣ can be computed for the two IBC LIC models separately, where yᵣ for the first model is equal to the average value of the template reference samples used in the first IBC LIC model creation, yᵣ for the second model is equal to the average value of the template reference samples used in the second IBC LIC model creation. In the third example, slope adjustment is applied to IBC LIC single models, which include IBC LIC mode with L-shape template, IBC LIC mode with only left template, and IBC LIC mode with only above template.

When applying slope adjustment for IBC LIC, different signaling method can be applied. For IBC AMVP mode, after signal the IBC LIC flag, another flag which indicates whether slope adjustment is applied is further signalled if the IBC LIC flag is true. If the flag which indicates whether slope adjustment is applied is true, the slope adjustment parameter is signalled. Different methods can be used to signal the slope adjustment parameter. For example, if the slope adjustment parameter is provided as an integer between −4 and 4, inclusive, the sign of the slope adjustment parameter can be signalled firstly, then the absolute value of the slope adjustment parameter can be signalled. The absolute value of the slope adjustment parameter can be binarized firstly as follow: value 1 is binarized as 0, value 2 is binarized as 10, value 3 is binarized as 110, value 4 is binarized as 111. After binarization, the absolute value of the slope adjustment parameter can be coded into bit stream with bypass mode or regular mode.

When slope adjustment is applied to different IBC LIC modes, the slope adjustment signalling method can be combined with the IBC LIC extension mode signalling method. In one example, slope adjustment is applied to IBC LIC mode with L-shape template. IBC LIC mode with only left template, and IBC LIC mode with only above template. In this example, for IBC AMVP mode, after signal the IBC LIC flag, the chosen IBC LIC mode is signalled if the IBC LIC flag is true. Then, another flag which indicates whether slope adjustment is applied is further signalled if the chosen IBC LIC mode is IBC LIC mode with L-shape template, IBC LIC mode with only left template, or IBC LIC mode with only above template. If the flag which indicates whether slope adjustment is applied is true, the slope adjustment parameter is signalled. In another example, slope adjustment is applied to IBC LIC mode with L-shape template, IBC LIC mode with only left template. IBC LIC mode with only above template, and multi-model IBC LIC mode with L-shape template. In this example, for IBC AMVP mode, after signal the IBC LIC flag, the chosen IBC LIC mode is signalled if the IBC LIC flag is true. Then, another flag which indicates whether slope adjustment is applied is further signalled if the chosen IBC LIC mode is IBC LIC mode with L-shape template, IBC LIC mode with only left template. IBC LIC mode with only above template, or multi-model IBC LIC mode with Lshape template. If the flag which indicates whether slope adjustment is applied is true, the slope adjustment parameter is signalled. In addition, the third flag which indicates whether slope adjustment is applied is further signalled if the chosen IBC LIC mode is multi-model IBC LIC mode with L-shape template. If the third flag which indicates whether slope adjustment is applied is true, the slope adjustment parameter is signalled. The reason for signalling the third flag is that there are two models in multi-model IBC LIC mode with L-shape template, and the slope adjustment parameters can be signalled independently for the two models. It should be noted that the signalling of the third flag and the corresponding slope adjustment parameter can also be omitted. In that condition, the two models in multi-model IBC LIC mode with L-shape template share the same slope adjustment parameter.

For IBC merge mode, different signalling methods can be applied. In the first method, slope adjustment for IBC LIC is turned off in IBC merge mode, then no signalling and action need to be conducted in IBC merge mode. In the second method, the slope adjustment parameter for IBC LIC is inherited from the merge candidates, then no signalling needs to be conducted in IBC merge mode. In the third method, a flag which indicates whether slope adjustment is applied is signalled. If the flag is true, the slope adjustment parameter is signalled similar to as in IBC AMVP mode. If the flag is true, the regular inheritance of IBC LIC flag will not be applied. If the flag is false, the regular inheritance of IBC LIC flag is applied. The flag which indicates whether slope adjustment is applied can be signalled in different conditions, for example, the flag is only signaled when the current block is not coded as IBC-CIIP, IBC-GPM, TM-Merge, or skip mode. In the fourth method, the regular inheritance of IBC LIC flag is turned off, and a flag which indicates whether the IBC LIC is applied is first signalled. If the flag is true, another flag which indicates whether slope adjustment is applied is further signalled. If the flag which indicates whether slope adjustment is applied is true, the slope adjustment parameter is signalled similar to as in IBC AMVP mode. The flag which indicates whether IBC LIC is applied can be signalled in different conditions, for example, the flag is only signaled when the current block is not coded as IBC-CHIP, IBC-GPM, or skip mode.

When applying slope adjustment for IBC LIC, the slope adjustment for IBC LIC can be applied in different channels. In one example, the slope adjustment for IBC LIC is only applied in luma component, and the slope adjustment for IBC LIC in chroma components is turned off. In another example, the slope adjustment for IBC LIC is applied to both luma channels and chroma components, different methods can be utilized to signal the slope adjustment parameters. In the first method, the luma and chroma components share the same slope adjustment parameters, and only one set of slope adjustment parameters needs to be signalled for both luma and chroma components. For example, the slope adjustment parameters are signalled in CU level. In the second method, the slope adjustment parameters for luma and chroma components are derived independently, and the slope adjustment parameters for luma and chroma components are signalled separately.

### Slope Adjustment for Filtered IBC

According to one or more embodiments of the disclosure, slope adjustment is applied to filtered IBC. Different methods may be used to achieve this goal.

Generally, filtered IBC is represented as follows:

$${Pred}_{filter} = c 0 * C + c 1 * N + c 2 * S + c 3 * E + c 4 * W + c 5 * P + c 6 * B$$

where the Pred_{filter} is the filtered prediction sample value and C, N, S, E, W are samples in the original prediction block. The nonlinear term P is represented as power of two of the center sample C and scaled to the sample value range of the content:

$$P = ( C * C + midVal ) ≫ bitDepth$$

The bias term B represents a scalar offset between the input and output and is set to middle luma value (512 for 10-bit content). The convolution parameters of c0, c1, c2, c3, c4, c5, c6 are obtained according to the template of current block and the reference samples of the template of current block as described in the background.

When slope adjustment is applied to filtered IBC, adjustments “u0”, “u1”, “u2”, “u3”, “u4”, “u5” to the convolution parameters are utilized to update the model to the following form:

$$\begin{matrix}{Pred}_{filter} = c 0 ’ * C + c 1 ’ * N + c 2 ’ * S + c 3 ’ * E + c 4 ’ * W + c 5 ’ * P + c 6 ’ * B \\ where \\ c 0 ’ = c 0 + u 0 \\ c 1 ’ = c 1 + u 1 \\ c 2 ’ = c 2 + u 2 \\ c 3 ’ = c 3 + u 3 \\ c 4 ’ = c 4 + u 4 \\ c 5 ’ = c 5 + u 5 \\ c 6 ’ = ( c 6 * B - u 0 * {y}_{rC} - u 1 * {y}_{rN} - u 2 * {y}_{rS} - u 3 * {y}_{rE} - u 4 * {y}_{rW} - u 5 * {y}_{rP} ) / B\end{matrix}$$

where y_{rC}, y_{rN}, y_{rS}, y_{rE}, y_{rW} and y_{rP} are equal to the average values of the central, north, south, east, west and the non-linear term of template reference samples used in the model creation. Similar to slope adjustment for CCLM and LIC, y_{rC}, y_{rN}, y_{rS}, y_{rE}, y_{rW} and y_{rP} are imported in order to provide a meaningful modification to the model.

In some embodiments of the present disclosure, all the adjustments to the convolution parameters or a subset of the adjustments to the convolution parameters can be utilized to update the model. For example, only adjustment “u0” to the convolution parameter is utilized to update the model, then the equation becomes the following form:

$$\begin{matrix}{Pred}_{filter} = c 0 ’ * C + c 1 * N + c 2 * S + c 3 * E + c 4 * W + c 5 * P + c 6 ’ * B \\ where \\ c 0 ’ = c 0 + u 0 \\ c 6 ’ = ( c 6 * B - u 0 * {y}_{rC} ) / B\end{matrix}$$

The adjustment parameters may be in different range. For example, same to slope adjustment for CCLM, the adjustment parameters are provided as an integer between −4 and 4, inclusive. The adjustment parameters may be defined in different granularities. For example, same to slope adjustment for CCLM, the unit of the adjustment parameters is ⅛th of the sample value of the filtered prediction block per one sample value of the original prediction block (for 10-bit content).

When applying slope adjustment for filtered IBC, different signaling methods can be applied. For IBC AMVP mode, after signal the filtered IBC flag, another flag which indicates whether slope adjustment is applied is further signalled if the filtered IBC flag is true. If the flag which indicates whether slope adjustment is applied is true, the adjustment parameters are further signalled, where the signalling method is similar to the slope adjustment parameter signalling method for IBC LIC in IBC AMVP mode.

For IBC merge mode, different signalling methods can be applied. In the first method, slope adjustment for filtered IBC is turned off in IBC merge mode, then no signalling and action need to be conducted in IBC merge mode. In the second method, the adjustment parameters for filtered IBC are inherited from the merge candidates, then no signalling needs to be conducted in IBC merge mode. In the third method, a flag which indicates whether slope adjustment is applied is signalled. If the flag is true, the adjustment parameters are signalled similar to as in IBC AMVP mode. If the flag is true, the regular inheritance of filtered IBC flag will not be applied. If the flag is false, the regular inheritance of filtered IBC flag is applied. The flag which indicates whether slope adjustment is applied can be signalled in different conditions, for example, the flag is only signaled when the current block is not coded as IBC-CIIP, IBC-GPM, TM-Merge, or skip mode. In the fourth method, the regular inheritance of filtered IBC flag is turned off, and a flag which indicates whether the filtered IBC is applied is first signalled. If the flag is true, another flag which indicates whether slope adjustment is applied is further signalled. If the flag which indicates whether slope adjustment is applied is true, the adjustment parameters are signalled similar to as in IBC AMVP mode. The flag which indicates whether filtered IBC is applied can be signalled in different conditions, for example, the flag is only signaled when the current block is not coded as IBC-CIIP, IBC-GPM, or skip mode.

### Slope Adjustment for Filtered Intra TMP

According to one or more embodiments of the disclosure, slope adjustment is applied to filtered Intra TMP. Different methods may be used to achieve this goal.

Generally, filtered Intra TMP is represented as follows:

$${Pred}_{filter} = c 0 * C + c 1 * N + c 2 * S + c 3 * E + c 4 * W + c 5 * B$$

where the Pred_{filter} is the filtered prediction sample value and C, N, S, E, W are samples in the original prediction block.

The bias term B represents a scalar offset between the input and output and is set to middle luma value (512 for 10-bit content). The convolution parameters of c0, c1, c2, c3, c4, c5 are obtained according to the template of current block and the reference samples of the template of current block as described in the background.

When slope adjustment is applied to filtered Intra TMP, adjustments “u0”, “u1”, “u2”, “u3”, “u4” to the convolution parameters are utilized to update the model to the following form:

$$\begin{matrix}{Pred}_{filter} = c 0 ’ * C + c 1 ’ * N + c 2 ’ * S + c 3 ’ * E + c 4 ’ * W + c 5 ’ * B \\ where \\ c 0 ’ = c 0 + u 0 \\ c 1 ’ = c 1 + u 1 \\ c 2 ’ = c 2 + u 2 \\ c 3 ’ = c 3 + u 3 \\ c 4 ’ = c 4 + u 4 \\ c 5 ’ = ( c 5 * B - u 0 * {y}_{rC} - u 1 * {y}_{rN} - u 2 * {y}_{rS} - u 3 * {y}_{rE} - u 4 * {y}_{rW} ) / B\end{matrix}$$

where y_{rC}, y_{rN}, y_{rS}, y_{rE} and y_{rW} are equal to the average values of the central, north, south, east and west of template reference samples used in the model creation. Similar to slope adjustment for CCLM and LIC, y_{rC}, y_{rN}, y_{rS}, y_{rE} and y_{rW} are imported in order to provide a meaningful modification to the model.

In some embodiments of the present disclosure, all the adjustments to the convolution parameters or a subset of the adjustments to the convolution parameters can be utilized to update the model. For example, only adjustment “u0” to the convolution parameter is utilized to update the model, then the equation becomes the following form:

$$\begin{matrix}{Pred}_{filter} = c 0 ’ * C + c 1 * N + c 2 * S + c 3 * E + c 4 * W + c 5 ’ B \\ where \\ c 0 ’ = c 0 + u 0 \\ c 5 ’ = ( c 5 * B - u 0 * {y}_{rC} ) / B\end{matrix}$$

The adjustment parameters may be in different range. For example, same to slope adjustment for CCLM, the adjustment parameters are provided as an integer between −4 and 4, inclusive. The adjustment parameters may be defined in different granularities. For example, same to slope adjustment for CCLM, the unit of the adjustment parameters is ⅛th of the sample value of the filtered prediction block per one sample value of the original prediction block (for 10-bit content).

When applying slope adjustment for filtered Intra TMP, different signaling method can be applied. For example, after signal the filtered Intra TMP flag, another flag which indicates whether slope adjustment is applied is further signalled if the filtered Intra TMP flag is true. If the flag which indicates whether slope adjustment is applied is true, the adjustment parameters are further signalled, where the signalling method is similar to the slope adjustment parameter signalling method for IBC LIC in IBC AMVP mode.

### Slope Adjustment for CCCM

According to one or more embodiments of the disclosure, slope adjustment is applied to CCCM. Different methods may be used to achieve this goal.

Generally, CCCM is represented as follows:

$$P r e {d}_{C h r o m a} = c 0 * C + c 1 * N + c 2 * S + c 3 * E + c 4 * W + c 5 * P + c 6 * B$$

where the Pred_{Chroma} is the predicted chroma sample value and C, N, S, E, W are samples in the corresponding luma reconstruction block. The nonlinear term P is represented as power of two of the center sample C and scaled to the sample value range of the content:

$$P = ( C * C + midVal ) >> bitDepth$$

The bias term B represents a scalar offset between the input and output and is set to middle luma value (512 for 10-bit content). The convolution parameters of c0, c1, c2, c3, c4, c5, c6 are obtained according to the template of current chroma block and the corresponding template of current luma block as described in the background.

When slope adjustment is applied to CCCM, adjustments “u0”, “u1”, “u2”, “u3”, “u4”, “u5” to the convolution parameters are utilized to update the model to the following form:

$${Pred}_{C h r o m a} = c {0}^{′} * C + c {1}^{′} * N + c {2}^{′} * S + c {3}^{′} * E + c {4}^{′} * W + c {5}^{′} * P + c {6}^{′} * B$$

$$where$$

$$c {0}^{′} = c 0 + u 0$$

$$c {1}^{′} = c 1 + u 1$$

$$c {2}^{′} = c 2 + u 2$$

$$c {3}^{′} = c 3 + u 3$$

$$c {4}^{′} = c 4 + u 4$$

$$c {5}^{′} = c 5 + u 5$$

$$c {6}^{′} = ( c 6 * B - u 0 * {y}_{r C} - u 1 * {y}_{r N} - u 2 * {y}_{r S} - u 3 * {y}_{r E} - u 4 * {y}_{r} w - u 5 * {y}_{r P} ) / B$$

where y_{rC}, y_{rN}, y_{rS}, y_{rE}, y_{rW} and y_{rP} are equal to the average values of the central, north, south, east, west and the non-linear term of template of current luma block samples used in the model creation. Similar to slope adjustment for CCLM and LIC, y_{rC}, y_{rN}, y_{rS}, y_{rE}, y_{rW} and y_{rP} are imported in order to provide a meaningful modification to the model.

In some embodiments of the present disclosure, all the adjustments to the convolution parameters or a subset of the adjustments to the convolution parameters can be utilized to update the model. For example, only adjustment “u0” to the convolution parameter is utilized to update the model, then the equation becomes the following form:

$$P r e {d}_{C h r o m a} = c {0}^{′} * C + c 1 * N + c 2 * S + c 3 * E + c 4 * W + c 5 * P + c {6}^{′} * B$$

$$where$$

$$c {0}^{′} = c 0 + u 0$$

$$c {6}^{′} = ( c 6 * B - u 0 * {y}_{rC} ) / B$$

As shown in the background, in real CCCM implementation, fixed offsets are removed from luma and chroma samples in each PU for each model. Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 << ( bitDepth - 1 )$$

and the chroma value is predicted using the following equation, where offsetChroma is equal to offsetCr and offsetCb for Cr and Cb components, respectively:

$$P r e {d}_{C h r o m a} = c 0 * {C}^{′} + c 1 * {N}^{′} + c 2 * {S}^{′} + c 3 * {E}^{′} + c 4 * {W}^{′} + c 5 * {P}^{′} + c 6 * B + offsetChroma$$

When slope adjustment is applied to CCCM in real implementation, adjustments “u0”, “u1”, “u2”, “u3”, “u4”, “u5” to the convolution parameters are utilized to update the model to the following form:

$$P r e {d}_{C h r o m a} = c {0}^{′} * {C}^{′} + c {1}^{′} * {N}^{′} + c {2}^{′} * {S}^{′} + c {3}^{′} * {E}^{′} + c {4}^{′} * {W}^{′} + c {5}^{′} * {P}^{′} + c {6}^{′} * {B}^{′} + OffsetChroma$$

$$where$$

$$c {0}^{′} = c 0 + u 0$$

$$c {1}^{′} = c 1 + u 1$$

$$c {2}^{′} = c 2 + u 2$$

$$c {3}^{′} = c 3 + u 3$$

$$c {4}^{′} = c 4 + u 4$$

$$c {5}^{′} = c 5 + u 5$$

$$c {6}^{′} = ( c 6 * B - u 0 * {y}_{{rC}^{′}} - u 1 * {y}_{{rN}^{′}} - u 2 * {y}_{{rS}^{′}} - u 3 * {y}_{{rE}^{′}} - u {4}^{*} {y}_{{rW}^{′}} - u 5 * {y}_{{rP}^{′}} ) / B$$

where y_{rC′}, y_{rN′}, y_{rS′}, y_{rE′}, y_{rW}′ and y_{rP}′ are equal to the average values of the central samples with offset, north samples with offset, south samples with offset, east samples with offset, west samples with offset and the corresponding non-linear term of the template of current luma block used in the model creation. Similar to slope adjustment for CCLM and LIC, y_{rC′}, y_{rN′}, y_{rS′}, y_{rE′}, y_{rW}′ and y_{rP}′ are imported in order to provide a meaningful modification to the model.

In some embodiments of the present disclosure, all the adjustments to the convolution parameters or a subset of the adjustments to the convolution parameters can be utilized to update the model. For example, only adjustment “u0” to the convolution parameter is utilized to update the model, then the equation becomes the following form:

$${Pred}_{C h r o m a} = c {0}^{′} * {C}^{′} + c 1 * {N}^{′} + c 2 * {S}^{′} + c 3 * {E}^{′} + c 4 * {W}^{′} + c 5 * {P}^{′} + c {6}^{′} * B + offsetChroma$$

$$where$$

$$c {0}^{′} = c 0 + u 0$$

$$c {6}^{′} = ( c 6 * B - u 0 * {y}_{{rC}^{′}} ) / B$$

The adjustment parameters may be in different range. For example, same to slope adjustment for CCLM, the adjustment parameters are provided as an integer between −4 and 4, inclusive. The adjustment parameters may be defined in different granularities. For example, same to slope adjustment for CCLM, the unit of the adjustment parameters is ⅛th of a chroma sample value per one luma sample value (for 10-bit content).

The slope adjustment may be applied to different CCCM modes. For example, similar to slope adjustment for CCLM model, slope adjustment is applied to CCCM mode with the L-shape template and multi-model CCCM mode with the L-shape template. When slope adjustment is applied for a multi-model CCCM mode with the L-shape template, both CCCM models can be adjusted and y_{rC} can be computed for the two CCCM models separately, where y_{rC} for the first model is equal to the average value of the template of current luma block samples used in the first CCCM model creation, y_{rC} for the second model is equal to the average value of the template of current luma block samples used in the second CCCM model creation.

For adjustment parameters signaling, as both CCCM and CCLM predict chroma samples with reconstructed luma samples. Similar slope adjustment parameter signaling method in CCLM can be applied to adjustment parameters signaling of CCCM, which makes the adjustment parameters signaling of CCCM is aligned with the slope adjustment parameter signaling method in CCLM.

### Slope Adjustment for GLM

According to one or more embodiments of the disclosure, slope adjustment is applied to GLM. Different methods may be used to achieve this goal.

Generally, two GLM modes are supported: a two-parameter GLM mode and a three-parameter GLM mode.

For the two-parameter GLM mode, it is represented as follows:

$$P r e {d}_{C h r o m a} = c 0 * G + c 1$$

For the three-parameter GLM mode, it is represented as follows:

$$P r e {d}_{C h r o m a} = c 0 * G + c 1 * L + c 2 * B$$

where the Pred_{Chroma} is the predicted chroma sample value, G is the luma sample gradient value in the corresponding luma reconstruction block, L is the down-sampled luma sample value in the corresponding luma reconstruction block, B is a scalar offset between the input and output and is set to middle luma value (512 for 10-bit content). The parameters of c0, c1, c2 are obtained according to the template of current chroma block and the corresponding template of current luma block as described in the background.

When slope adjustment is applied to two-parameter GLM mode, adjustment “u0” to the slope parameter is utilized to update the model to the following form:

$$P r e {d}_{C h r o m a} = c {0}^{′} * G + c {1}^{′}$$

$$where$$

$$c {0}^{′} = c 0 + u 0$$

$$c {1}^{′} = c 1 - u 0 * {y}_{G}$$

where y_{G} is equal to the average value of the luma sample gradient of template of current luma block samples used in the model creation. Similar to slope adjustment for CCLM and LIC, y_{G} is imported in order to provide a meaningful modification to the model.

When slope adjustment is applied to three-parameter GLM mode, adjustments “u0”, “u1” to the parameters are utilized to update the model to the following form:

$$P r e {d}_{C h r o m a} = c {0}^{′} * G + c {1}^{′} * L + c {2}^{′} * B$$

$$where$$

$$c 0 ' = c 0 + u 0$$

$$c {1}^{′} = c 1 + u 1$$

$$c {2}^{′} = ( c 2 * B - u 0 * {y}_{G} - u 1 * {y}_{L} ) / B$$

where y_{G} and y_{L} are equal to the average values of the luma sample gradient and down-sampled luma sample value of template of current luma block samples used in the model creation. Similar to slope adjustment for CCLM and LIC, y_{G} and y_{L} are imported in order to provide a meaningful modification to the model.

In some embodiments of the present disclosure, all the adjustments to the parameters or a subset of the adjustments to the parameters can be utilized to update the model. For example, only adjustment “u0” to the convolution parameter is utilized to update the model, then the equation becomes the following form:

$$P r e {d}_{C h r o m a} = c {0}^{′} * G + c 1 * L + c {2}^{′} * B$$

$$where$$

$$c {0}^{′} = c 0 + u 0$$

$$c {2}^{′} = ( c 2 * B - u 0 * {y}_{G} ) / B$$

The adjustment parameters may be in different range. For example, same to slope adjustment for CCLM, the adjustment parameters are provided as an integer between −4 and 4, inclusive. The adjustment parameters may be defined in different granularities. For example, same to slope adjustment for CCLM, the unit of the adjustment parameters is ⅛th of a chroma sample value per one luma sample value (for 10-bit content).

For adjustment parameters signaling, as both GLM and CCLM predict chroma samples with reconstructed luma samples. Similar slope adjustment parameter signaling method in CCLM can be applied to adjustment parameters signaling of GLM, which makes the adjustment parameters signaling of GLM is aligned with the slope adjustment parameter signaling method in CCLM.

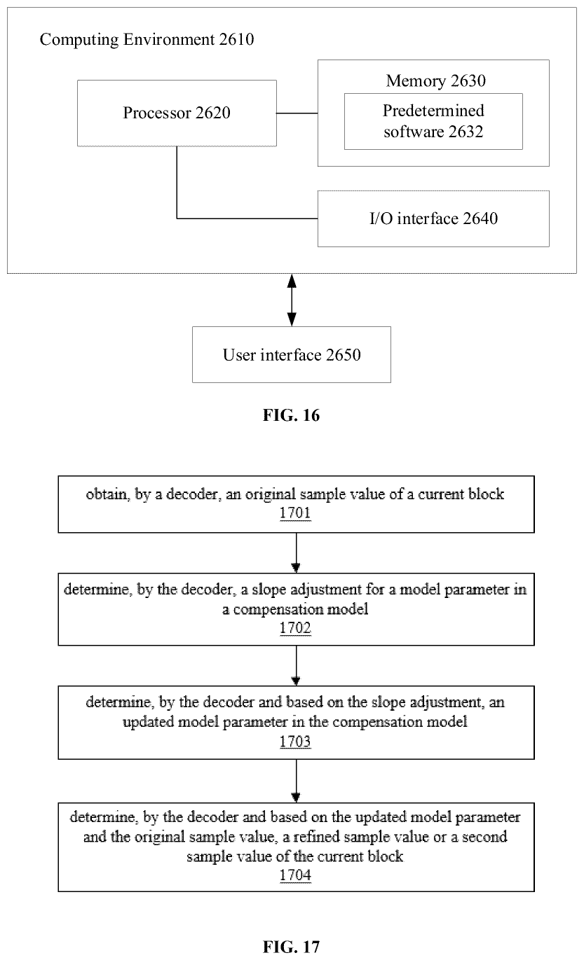

FIG. 16 shows a computing environment 2610 coupled with a user interface 2650. The computing environment 2610 can be part of a data processing server. The computing environment 2610 includes a processor 2620, a memory 2630, and an Input/Output (I/O) interface 2640.

The processor 2620 typically controls overall operations of the computing environment 2610, such as the operations associated with display, data acquisition, data communications, and image processing. The processor 2620 may include one or more processors to execute instructions to perform all or some of the steps in the above-described methods. Moreover, the processor 2620 may include one or more modules that facilitate the interaction between the processor 2620 and other components. The processor may be a Central Processing Unit (CPU), a microprocessor, a single chip machine, a Graphical Processing Unit (GPU), or the like.

The memory 2630 is configured to store various types of data to support the operation of the computing environment 2610. The memory 2630 may include predetermined software 2632. Examples of such data includes instructions for any applications or methods operated on the computing environment 2610, video datasets, image data, etc. The memory 2630 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 2640 provides an interface between the processor 2620 and peripheral interface modules, such as a keyboard, a click wheel, buttons, and the like. The buttons may include but are not limited to, a home button, a start scan button, and a stop scan button. The I/O interface 2640 can be coupled with an encoder and decoder.

In one or more embodiments, there is also provided a non-transitory computer-readable storage medium including a plurality of programs, for example, in the memory 2630, executable by the processor 2620 in the computing environment 2610, for performing the above-described methods and/or storing a bitstream generated by the encoding method described above or a bitstream to be decoded by the decoding method described above. In one example, the plurality of programs may be executed by the processor 2620 in the computing environment 2610 to receive (for example, from the video encoder 20 in FIG. 2) a bitstream or data stream including encoded video information (for example, video blocks representing encoded video frames, and/or associated one or more syntax elements, etc.), and may also be executed by the processor 2620 in the computing environment 2610 to perform the decoding method described above according to the received bitstream or data stream. In another example, the plurality of programs may be executed by the processor 2620 in the computing environment 2610 to perform the encoding method described above to encode video information (for example, video blocks representing video frames, and/or associated one or more syntax elements, etc.) into a bitstream or data stream, and may also be executed by the processor 2620 in the computing environment 2610 to transmit the bitstream or data stream (for example, to the video decoder 30 in FIG. 3). Alternatively, the non-transitory computer-readable storage medium may have stored therein a bitstream or a data stream including encoded video information (for example, video blocks representing encoded video frames, and/or associated one or more syntax elements, etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In one or more embodiments, there is provided a bitstream generated by the encoding method described above or a bitstream to be decoded by the decoding method described above. In one or more embodiments, there is provided a bitstream including encoded video information generated by the encoding method described above or encoded video information to be decoded by the decoding method described above.

In one or more embodiments, the is also provided a computing device including one or more processors (for example, the processor 2620); and the non-transitory computer-readable storage medium or the memory 2630 having stored therein a plurality of programs executable by the one or more processors, wherein the one or more processors, upon execution of the plurality of programs, are configured to perform the above-described methods.

In one or more embodiments, there is also provided a computer program product having instructions for storage or transmission of a bitstream including encoded video information generated by the encoding method described above or encoded video information to be decoded by the decoding method described above. In one or more embodiments, there is also provided a computer program product including a plurality of programs, for example, in the memory 2630, executable by the processor 2620 in the computing environment 2610, for performing the above-described methods. For example, the computer program product may include the non-transitory computer-readable storage medium.

In one or more embodiments, the computing environment 2610 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

FIG. 17 is a flowchart illustrating a method for video decoding in accordance with some examples of the present disclosure. At step 1701, the method includes: obtaining, by a decoder, an original sample value of a current block. At step 1702, the method includes: obtaining, by the decoder, a slope adjustment for a model parameter in a compensation model. At step 1703, the method includes: by the decoder and based on the slope adjustment, an updated model parameter in the compensation model. At step 1704, the method includes: determining, by the decoder and based on the updated model parameter and the original sample value, a refined sample value or a second sample value of the current block.

In one or more embodiments, the compensation model includes at least one of following models: an Intra Block Copy (IBC) Local Illumination Compensation (LIC) model, a filtered IBC model, a filtered Intra Template Matching Prediction (Intra TMP) model, a Convolutional Cross-Component Model (CCCM), or a Gradient Linear Model (GLM).

In one or more embodiments, the compensation model includes an Intra Block Copy (IBC) Local Illumination Compensation (LIC) model, and the model parameter includes a slope parameter and a bias parameter; wherein the determining the updated model parameter in the compensation model includes: determining, by the decoder and based on the slope adjustment, an updated slope parameter for the original sample value; determining, by the decoder and based on the slope adjustment and a first adjustment, an updated bias parameter.

In one or more embodiments, determining the updated slope parameter for the original sample value includes: obtaining, by the decoder, the updated slope parameter for the original sample value by summing the slope adjustment and the slope parameter; and/or, wherein determining the updated bias parameter includes: obtaining, by the decoder, the updated bias parameter by calculating a difference between the bias parameter and a product of the slope adjustment and the first adjustment.

In one or more embodiments, the first adjustment includes an average value of reference samples for the IBC LIC model.

In one or more embodiments, a range of the slope adjustment is pre-determined, wherein granularity of the slope adjustment is determined based on a refined sample value of a prediction block.

In one or more embodiments, the compensation model is a single model with L-shape template or a multi-model with L-shape template; or wherein the compensation model is a single model with L-shape template, or a single model with left template, or a single model with top template, or a multi-model with L-shape template.

In one or more embodiments, the compensation model includes one of following models: an Intra Block Copy (IBC) Local Illumination Compensation (LIC) model with IBC Advanced Motion Vector Prediction (AMVP) mode, a filtered IBC model with IBC AMVP mode, or a filtered Intra Template Matching Prediction (Intra TMP) model, wherein the method further includes: receiving, by the decoder, a mode flag, wherein the mode flag is an IBC LIC flag, a filtered IBC flag, or a filtered Intra TMP flag; in response to determining the mode flag is true, receiving, by the decoder, a slope adjustment flag indicating whether the slope adjustment is applied; and wherein determining the slope adjustment for the model parameter in a compensation model includes: in response to determining the slope adjustment flag is true, receiving, by the decoder, the slope adjustment for the model parameter.

In one or more embodiments, the compensation model includes an Intra Block Copy (IBC) Local Illumination Compensation (LIC) model with IBC merge mode or a filtered IBC model with IBC merge mode, wherein the method further includes: determining, by the decoder, that the slope adjustment is disabled; in response to determining that the slope adjustment is disabled, disabling, by the decoder, the slope adjustment for the model parameter.

In one or more embodiments, the compensation model includes an Intra Block Copy (IBC) Local Illumination Compensation (LIC) model with IBC merge mode or a filtered IBC model with IBC merge mode, wherein determining the slope adjustment for the model parameter in a compensation model includes: deriving, by the decoder, the slope adjustment for the model parameter from merge candidates.

In one or more embodiments, the compensation model includes an Intra Block Copy (IBC) Local Illumination Compensation (LIC) model with IBC merge mode or a filtered IBC model with IBC merge mode, wherein the method further includes: receiving, by the decoder, a flag indicating whether the slope adjustment is applied; wherein determining the slope adjustment for the model parameter in a compensation model includes: in response to determining that the flag is false, obtaining, by the decoder, regular inheritance of IBC LIC flag or filtered IBC flag; and in response to determining that the flag is true, obtaining, by the decoder, the slope adjustment in IBC AMVP mode.

In one or more embodiments, the compensation model includes an Intra Block Copy (IBC) Local Illumination Compensation (LIC) model with IBC merge mode or a filtered IBC model with IBC merge mode, wherein the method further includes: in response to determining that regular inheritance of IBC LIC flag or filtered IBC flag is disabled, receiving, by the decoder, a first flag indicating whether the IBC LIC model is applied or the first flag indicating whether the filtered IBC model is applied; in response to determining that the first flag is true, receiving, by the decoder, a second flag indicating whether the slope adjustment for the model parameter is applied; and wherein determining the slope adjustment for the model parameter in a compensation model includes: in response to determining the second flag is true, receiving, by the decoder, the slope adjustment for the model parameter in IBC Advanced Motion Vector Prediction (AMVP) mode.

In one or more embodiments, the compensation model includes one of following models: a filtered IBC model, a filtered Intra Template Matching Prediction (Intra TMP) model, or a Convolutional Cross-Component Model (CCCM), and the model parameter includes multiple convolution parameters; wherein the determining the updated model parameter in the compensation model includes: determining, by the decoder and based on the slope adjustment, a first updated convolution parameter of the multiple convolution parameters for the original sample value; determining, by the decoder and based on the slope adjustment and a second adjustment, a second updated convolution parameter of the multiple convolution parameters for a scalar offset.

In one or more embodiments, determining the first updated convolution parameter for the original sample value includes: obtaining, by the decoder, the first updated convolution parameter for the original sample value by summing a corresponding slope adjustment of multiple slope adjustments and a corresponding parameter of the multiple convolution parameters.

In one or more embodiments, the second adjustment includes at least one average sample value of reference samples for the compensation model; wherein determining the second updated convolution parameter for the scalar offset includes: determining, by the decoder and based on at least one slope adjustment of multiple slope adjustments and the at least one average sample value of reference samples, the second updated convolution parameter for the scalar offset.

In one or more embodiments, determining the refined sample value or a second sample value of the current block includes: determining, by the decoder and based on the original sample value, the first updated convolution parameter, the scalar offset and the second updated convolution parameter, the refined sample value or a second sample value of the current block; wherein the original sample value includes a central sample value and additional plurality of sample values.

In one or more embodiments, the at least one average sample value of reference samples includes at least one average sample value of central, north, south, east, west and the non-linear term of template reference samples.

In one or more embodiments, the compensation model includes a Convolutional Cross-Component Model (CCCM), the method further including: obtaining, by the decoder, an offset sample value for the original sample value; determining, by the decoder and based on the offset sample value and the original sample value, an updated sample value; wherein determining the refined sample value or a second sample value of the current block includes: determining, by the decoder and based on the updated sample value, the first updated convolution parameter, the scalar offset and the second updated convolution parameter, the refined sample value or a second sample value of the current block.

In one or more embodiments, the compensation model includes a two-parameter GLM, wherein the original sample value is a luma sample gradient value of a luma reconstruction block and the second sample value is a predicted chroma sample value, wherein the model parameter includes a slope parameter and a bias parameter; wherein the determining the updated model parameter in the compensation model includes: determining, by the decoder and based on the slope adjustment, an updated slope parameter for the luma sample gradient value; determining, by the decoder and based on the slope adjustment and a third adjustment, an updated bias parameter; wherein determining the refined sample value or the second sample value of the current block includes: determining, by the decoder and based on the luma sample gradient value, the updated slope parameter and the updated bias parameter, the predicted chroma sample value.

In one or more embodiments, the third adjustment includes an average value of luma sample gradient of reference samples for the two parameter GLM.

In one or more embodiments, the compensation model includes a three-parameter GLM, wherein the original sample value is a luma sample gradient value of a luma reconstruction block and the second sample value is a predicted chroma sample value, wherein the model parameter includes at least one slope parameter; wherein the determining the updated model parameter in the compensation model includes: determining, by the decoder and based on the slope adjustment, a first updated slope parameter for the luma sample gradient value; determining, by the decoder and based on the at least one slope parameter and a fourth adjustment, a second updated slope parameter for a scalar offset; wherein determining the refined sample value or the second sample value of the current block includes: determining, by the decoder and based on the luma sample gradient value, the first updated slope parameter, the scalar offset, the second updated slope parameter, a down-sampled luma sample value and a third slope parameter, the predicted chroma sample value.

In one or more embodiments, the method further including: determining, by the decoder and based on the slope adjustment, a third updated slope parameter for the down-sampled luma sample value in a corresponding luma reconstruction block; wherein determining the refined sample value or the second sample value of the current block includes: determining, by the decoder and based on the luma sample gradient value, the first updated slope parameter, the scalar offset, the second updated slope parameter, the down-sampled luma sample value and the third updated parameter, the predicted chroma sample value.

In one or more embodiments, the fourth adjustment includes an average value of luma sample gradient of reference samples for the three parameter-GLM, and/or, an average value of down-sampled luma sample value of reference samples for the three-parameter GLM.

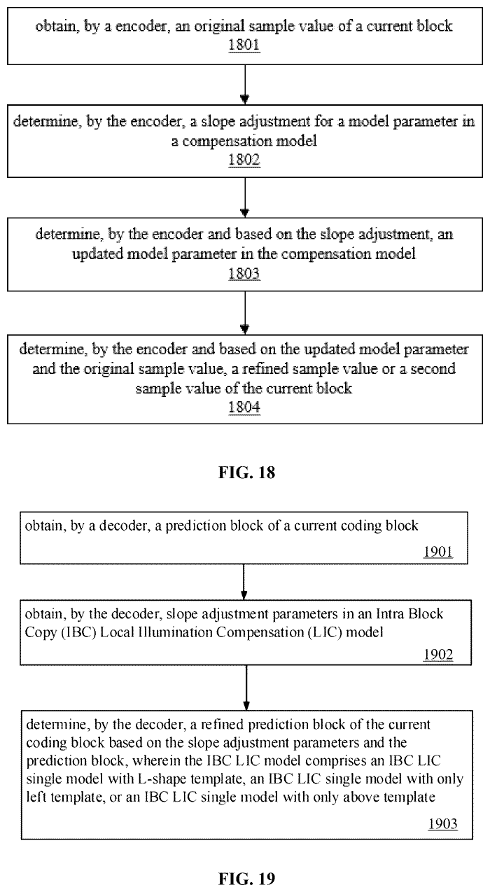

FIG. 18 is a flowchart illustrating a method for video encoding in accordance with some examples of the present disclosure. At step 1801, the method includes: obtaining, by an encoder, an original sample value of a current block. At step 1802, the method includes: determining, by the encoder, a slope adjustment for a model parameter in a compensation model. At step 1803, the method includes: determining, by the encoder and based on the slope adjustment, an updated model parameter in the compensation model. At step 1804, the method includes: determining, by the encoder and based on the updated model parameter and the original sample value, a refined sample value or a second sample value of the current block.

In one or more embodiments, the compensation model includes at least one of following models: an Intra Block Copy (IBC) Local Illumination Compensation (LIC) model, a filtered IBC model, a filtered Intra Template Matching Prediction (Intra TMP) model, a Convolutional Cross-Component Model (CCCM), or a Gradient Linear Model (GLM).

In one or more embodiments, the compensation model includes an IBC LIC model, and the model parameter includes a slope parameter and a bias parameter; wherein the determining the updated model parameter in the compensation model includes: determining, by the encoder and based on the slope adjustment, an updated slope parameter for the original sample value; determining, by the encoder and based on the slope adjustment and a first adjustment, an updated bias parameter.

In one or more embodiments, determining the updated slope parameter for the original sample value includes: obtaining, by the encoder, the updated slope parameter for the original sample value by summing the slope adjustment and the slope parameter; and/or, wherein determining the updated bias parameter includes: obtaining, by the encoder, the updated bias parameter by calculating a difference between the bias parameter and a product of the slope adjustment and the first adjustment.

In one or more embodiments, the first adjustment includes an average value of reference samples for the IBC LIC model.

In one or more embodiments, a range of the slope adjustment is pre-determined, wherein granularity of the slope adjustment is determined based on a refined sample value of a prediction block.

In one or more embodiments, the compensation model is a single model with L-shape template or a multi-model with L-shape template; or wherein the compensation model is a single model with L-shape template, or a single model with left template, or a single model with top template, or a multi-model with L-shape template.

In one or more embodiments, the compensation model includes one of following models: an Intra Block Copy (IBC) Local Illumination Compensation (LIC) model with IBC Advanced Motion Vector Prediction (AMVP) mode, a filtered IBC model with IBC AMVP mode, or a filtered Intra Template Matching Prediction (Intra TMP) model, wherein the method further includes: signaling, by the encoder, a mode flag, wherein the mode flag is an IBC LIC flag, a filtered IBC flag, or a filtered Intra TMP flag; in response to determining the mode flag is true, signaling, by the encoder, a slope adjustment flag indicating whether the slope adjustment is applied; and wherein determining the slope adjustment for the model parameter in a compensation model includes: in response to determining the slope adjustment flag is true, applying, by the encoder, the slope adjustment for the model parameter.

In one or more embodiments, the compensation model includes an Intra Block Copy (IBC) Local Illumination Compensation (LIC) model with IBC merge mode or a filtered IBC model with IBC merge mode, wherein the method further includes: determining, by the encoder, that the slope adjustment is disabled; in response to determining that the slope adjustment is disabled, disabling, by the encoder, the slope adjustment for the model parameter.

In one or more embodiments, the compensation model includes an Intra Block Copy (IBC) Local Illumination Compensation (LIC) model with IBC merge mode or a filtered IBC model with IBC merge mode, wherein determining the slope adjustment for the model parameter in a compensation model includes: deriving, by the encoder, the slope adjustment for the model parameter from merge candidates.

In one or more embodiments, the compensation model includes an Intra Block Copy (IBC) Local Illumination Compensation (LIC) model with IBC merge mode or a filtered IBC model with IBC merge mode, wherein the method further includes: signaling, by the encoder, a flag indicating whether the slope adjustment is applied; wherein determining the slope adjustment for the model parameter in a compensation model includes: in response to determining that the flag is false, applying, by the encoder, regular inheritance of IBC LIC flag or filtered IBC flag; and in response to determining that the flag is true, applying, by the encoder, the slope adjustment in IBC AMVP mode.

In one or more embodiments, the compensation model includes an Intra Block Copy (IBC) Local Illumination Compensation (LIC) model with IBC merge mode or a filtered IBC model with IBC merge mode, wherein the method further includes: in response to determining that regular inheritance of IBC LIC flag or filtered IBC flag is disabled, signaling, by the encoder, a first flag indicating whether the IBC LIC model is applied or the first flag indicating whether the filtered IBC model is applied; in response to determining that the first flag is true, signaling, by the encoder, a second flag indicating whether the slope adjustment for the model parameter is applied; and wherein determining the slope adjustment for the model parameter in a compensation model includes: in response to determining the second flag is true, applying, by the encoder, the slope adjustment for the model parameter in IBC Advanced Motion Vector Prediction (AMVP) mode.

In one or more embodiments, the compensation model includes one of following models: a filtered IBC model, a filtered Intra Template Matching Prediction (Intra TMP) model, or a Convolutional Cross-Component Model (CCCM), and the model parameter includes multiple convolution parameters; wherein the determining the updated model parameter in the compensation model includes: determining, by the encoder and based on the slope adjustment, a first updated convolution parameter of the multiple convolution parameters for the original sample value; determining, by the encoder and based on the slope adjustment and a second adjustment, a second updated convolution parameter of the multiple convolution parameters for a scalar offset.

In one or more embodiments, determining the first updated convolution parameter for the original sample value includes: obtaining, by the encoder, the first updated convolution parameter for the original sample value by summing a corresponding slope adjustment of multiple slope adjustments and a corresponding parameter of the multiple convolution parameters.

In one or more embodiments, the second adjustment includes at least one average sample value of reference samples for the compensation model; wherein determining the second updated convolution parameter for the scalar offset includes: determining, by the encoder and based on at least one slope adjustment of multiple slope adjustments and the at least one average sample value of reference samples, the second updated convolution parameter for the scalar offset.

In one or more embodiments, determining the refined sample value or a second sample value of the current block includes: determining, by the encoder and based on the original sample value, the first updated convolution parameter, the scalar offset and the second updated convolution parameter, the refined sample value or a second sample value of the current block; wherein the original sample value includes a central sample value and additional plurality of sample values.

In one or more embodiments, the at least one average sample value of reference samples includes at least one average sample value of central, north, south, east, west and the non-linear term of template reference samples.

In one or more embodiments, the compensation model includes a Convolutional Cross-Component Model (CCCM), the method further including: obtaining, by the encoder, an offset sample value for the original sample value; determining, by the encoder and based on the offset sample value and the original sample value, an updated sample value; wherein determining the refined sample value or a second sample value of the current block includes: determining, by the encoder and based on the updated sample value, the first updated convolution parameter, the scalar offset and the second updated convolution parameter, the refined sample value or a second sample value of the current block.

In one or more embodiments, the compensation model includes a two-parameter GLM, wherein the original sample value is a luma sample gradient value of a luma reconstruction block and the second sample value is a predicted chroma sample value, wherein the model parameter includes a slope parameter and a bias parameter; wherein the determining the updated model parameter in the compensation model includes: determining, by the encoder and based on the slope adjustment, an updated slope parameter for the luma sample gradient value; determining, by the encoder and based on the slope adjustment and a third adjustment, an updated bias parameter; wherein determining the refined sample value or the second sample value of the current block includes: determining, by the encoder and based on the luma sample gradient value, the updated slope parameter and the updated bias parameter, the predicted chroma sample value.

In one or more embodiments, the third adjustment includes an average value of luma sample gradient of reference samples for the two parameter GLM.

In one or more embodiments, the compensation model includes a three-parameter GLM, wherein the original sample value is a luma sample gradient value of a luma reconstruction block and the second sample value is a predicted chroma sample value, wherein the model parameter includes at least one slope parameter; wherein the determining the updated model parameter in the compensation model includes: determining, by the encoder and based on the slope adjustment, a first updated slope parameter for the luma sample gradient value; determining, by the encoder and based on the at least one slope parameter and a fourth adjustment, a second updated slope parameter for a scalar offset; wherein determining the refined sample value or the second sample value of the current block includes: determining, by the encoder and based on the luma sample gradient value, the first updated slope parameter, the scalar offset, the second updated slope parameter, a down-sampled luma sample value and a third slope parameter, the predicted chroma sample value.

In one or more embodiments, the method further including: determining, by the encoder and based on the slope adjustment, a third updated slope parameter for the down-sampled luma sample value in a corresponding luma reconstruction block; wherein determining the refined sample value or the second sample value of the current block includes: determining, by the encoder and based on the luma sample gradient value, the first updated slope parameter, the scalar offset, the second updated slope parameter, the down-sampled luma sample value and the third updated parameter, the predicted chroma sample value.

In one or more embodiments, the fourth adjustment includes an average value of luma sample gradient of reference samples for the three-parameter GLM, and/or, an average value of down-sample luma sample value of reference samples for the three-parameter GLM.

FIG. 19 is a flowchart illustrating a method for video decoding in accordance with some examples of the present disclosure. At step 1901, the method includes: obtaining, by a decoder, a prediction block of a current coding block. The prediction block may be a compensated prediction block obtained based on an original prediction block and the current coding block. A linear model with 2 parameters may be used for compensating the illumination variation between the prediction block and current block. The 2 parameters may include a slope parameter and a bias parameter. At step 1902, the method includes: obtaining, by the decoder, slope adjustment parameters in an Intra Block Copy (IBC) Local Illumination Compensation (LIC) model. The slope adjustment parameters may include a slope adjustment for the slope parameter and a bias adjustment for the bias parameter. At step 1703, the method includes: determining, by the decoder, a refined prediction block of the current coding block based on the slope adjustment parameters and the prediction block, wherein the IBC LIC model includes an IBC LIC single model with L-shape template, an IBC LIC single model with only left template, or an IBC LIC single model with only above template. IBC-LIC is a coding tool which compensates the local illumination variation within a picture between the CU coded with IBC and its prediction block with a linear equation. The parameters of the linear equation are derived same as LIC for inter prediction except that the reference template is generated using block vector in IBC-LIC.

In one or more embodiments, obtaining the slope adjustment parameters includes: in response to determining that at least one flag signaled by an encoder is true, obtaining the slope adjustment parameters signaled by the encoder.

In one or more embodiments, the IBC LIC model is applied with an IBC advanced motion vector prediction (AMVP) mode, and in response to determining that at least one flag signaled by an encoder is true, obtaining the slope adjustment parameters signaled by the encoder includes: in response to determining that an IBC LIC flag signaled by the encoder is true, determining a model index signaled by the encoder indicating applying a selected IBC LIC model, and determining that a slope adjustment flag signaled by the encoder indicating whether the slope adjustment parameters are applied to the selected IBC LIC mode is true, obtaining the slope adjustment parameters signaled by the encoder, wherein the selected IBC LIC model is an IBC LIC single model with L-shape template, an IBC LIC single model with only left template, or an IBC LIC single model with only above template.

In one or more embodiments, the IBC LIC model further includes an IBC LIC multi-model with L-shape template, and the IBC LIC model is applied with an AMVP mode, and in response to determining that at least one flag signaled by an encoder is true, obtaining the slope adjustment parameters signaled by the encoder includes: in response to determining that an IBC LIC flag signaled by the encoder is true, determining a model index signaled by the encoder indicating applying the IBC LIC multi-model with L-shape template, and determining that a slope adjustment flag for each model of the IBC LIC multi-model is true, obtaining the slope adjustment parameters signaled by the encoder for each model of the IBC LIC multi-model, wherein the slope adjustment flag is signaled by the encoder indicating whether the slope adjustment parameters are applied to a model of the IBC LIC multi-model.

In one or more embodiments, the IBC LIC model further includes an IBC LIC multi-model with L-shape template, and the IBC LIC model is applied with an AMVP mode, and in response to determining that at least one flag signaled by an encoder is true, obtaining the slope adjustment parameters signaled by the encoder includes: in response to determining that an IBC LIC flag signaled by the encoder is true, determining a model index signaled by the encoder indicating applying the IBC LIC multi-model with L-shape template, and determining that a slope adjustment flag for a first model of the IBC LIC multi-model is true, obtaining the slope adjustment parameters signaled by the encoder for the first model, and applying the slope adjustment parameters for a second model of the IBC LIC multi-model, wherein the slope adjustment flag is signaled by the encoder indicating whether the slope adjustment parameters are applied to the first model of the IBC LIC multi-model.

In one or more embodiments, determining the refined prediction block of the current coding block based on the slope adjustment parameters and the prediction block includes: determining refined luma components of the refined prediction block based on the slope adjustment parameters and the prediction block; determining refined chroma components of the refined prediction block based on the slope adjustment parameters and the prediction block; or determining both refined luma components and refined chroma components of the refined prediction block based on the slope adjustment parameters and the prediction block.

In one or more embodiments, determining both refined luma components and refined chroma components of the refined prediction block based on the slope adjustment parameters and the prediction block includes: determining both refined luma components and refined chroma components of the refined prediction block based on same slope adjustment parameters; or determining refined luma components of the refined prediction block based on luma slope adjustment parameters, and determining refined chroma components of the refined prediction block based on chroma slope adjustment parameters, wherein the luma slope adjustment parameter and the chroma slope adjustment parameter are derived independently by the encoder or signaled separately by the encoder.

FIG. 20 is a flowchart illustrating a method for video encoding in accordance with some examples of the present disclosure. At step 2001, the method includes: obtaining, by an encoder, a prediction block of a current coding block. The prediction block may be a compensated prediction block obtained based on an original prediction block and the current coding block. A linear model with 2 parameters may be used for compensating the illumination variation between the prediction block and current block. The 2 parameters may include a slope parameter and a bias parameter. At step 2002, the method includes: obtaining, by the encoder, slope adjustment parameters in an Intra Block Copy (IBC) Local Illumination Compensation (LIC) model. The slope adjustment parameters may include a slope adjustment for the slope parameter and a bias adjustment for the bias parameter. At step 2003, the method includes: signaling, by the encoder, the slope adjustment parameters for a decoder determining a refined prediction block of the current coding block based on the slope adjustment parameters and the prediction block, wherein the IBC LIC model includes an IBC LIC single model with L-shape template, an IBC LIC single model with only left template, or an IBC LIC single model with only above template. IBC-LIC is a coding tool which compensates the local illumination variation within a picture between the CU coded with IBC and its prediction block with a linear equation. The parameters of the linear equation are derived same as LIC for inter prediction except that the reference template is generated using block vector in IBC-LIC.

In one or more embodiments, the method further includes: signaling a slope adjustment flag to the decoder; and signaling the slope adjustment parameters for the decoder determining a refined prediction block of the current coding block based on the slope adjustment parameters and the prediction block includes: in response to determining that the slope adjustment flag is true, signaling the slope adjustment parameters to the decoder.

In one or more embodiments, the IBC LIC model is applied with an IBC advanced motion vector prediction (AMVP) mode, and the slope adjustment flag is configured to indicate whether the slope adjustment parameters are applied to a selected IBC LIC mode, and the method further includes: signaling, by the encoder, an IBC LIC flag to the decoder; and in response to determining that the IBC LIC flag is true, signaling, by the encoder, a model index to the decoder indicating applying the selected IBC LIC model, wherein the selected IBC LIC model is an IBC LIC single model with L-shape template, an IBC LIC single model with only left template, or an IBC LIC single model with only above template.

In one or more embodiments, the IBC LIC model further includes an IBC LIC multi-model with L-shape template, the IBC LIC model is applied with an AMVP mode, the slope adjustment flag is configured to indicate whether the slope adjustment parameters are applied to a model of the IBC LIC multi-model, and the method further includes: signaling, by the encoder, an IBC LIC flag to the decoder; and in response to determining that the IBC LIC flag is true, signaling, by the encoder, a model index to the decoder indicating applying the IBC LIC multi-model with L-shape template, wherein signaling the slope adjustment flag to the decoder includes: signaling, by the encoder, the slope adjustment flag for each model of the IBC LIC multi-model.

In one or more embodiments, the IBC LIC model further includes an IBC LIC multi-model with L-shape template, the IBC LIC model is applied with an AMVP mode, the slope adjustment flag is configured to indicate whether the slope adjustment parameters are applied to a first model of the IBC LIC multi-model, and the method further includes: signaling, by the encoder, an IBC LIC flag to the decoder; and in response to determining that the IBC LIC flag is true, signaling, by the encoder, a model index to the decoder indicating applying the IBC LIC multi-model with L-shape template, wherein the decoder is configured to, in response to determining that the IBC LIC flag is true, determining the model index indicating applying the IBC LIC multi-model with L-shape template, and determining that the slope adjustment flag is true, apply the slope adjustment parameters for a second model of the IBC LIC multi-model.

In one or more embodiments, signaling the slope adjustment parameters for the decoder determining a refined prediction block of the current coding block based on the slope adjustment parameters and the prediction block includes: signaling, by the encoder, the slope adjustment parameters for the decoder determining refined luma components of the refined prediction block based on the slope adjustment parameters and the prediction block; signaling, by the encoder, the slope adjustment parameters for the decoder determining refined chroma components of the refined prediction block based on the slope adjustment parameters and the prediction block; or signaling, by the encoder, the slope adjustment parameters for the decoder determining both refined luma components and refined chroma components of the refined prediction block based on the slope adjustment parameters and the prediction block.

In one or more embodiments, signaling the slope adjustment parameters for the decoder determining both refined luma components and refined chroma components of the refined prediction block based on the slope adjustment parameters and the prediction block includes: signaling same slope adjustment parameters for the decoder determining both refined luma components and refined chroma components of the refined prediction block; or signaling luma slope adjustment parameters and chroma slope adjustment parameters for the decoder determining refined luma components of the refined prediction block based on the luma slope adjustment parameters, and determining refined chroma components of the refined prediction block based on the chroma slope adjustment parameters, wherein the luma slope adjustment parameter and the chroma slope adjustment parameter are derived independently by the encoder or signaled separately by the encoder.

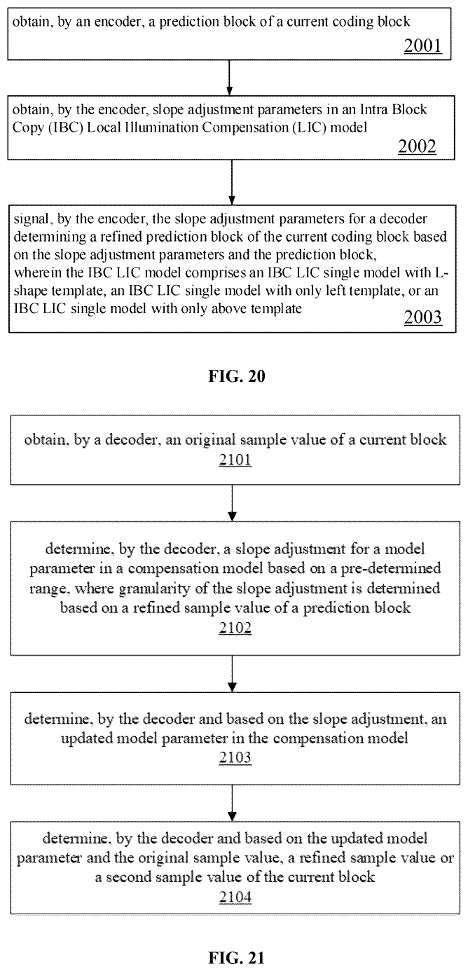

FIG. 21 is a flowchart illustrating a method for video decoding in accordance with some examples of the present disclosure. At step 2101, the method includes: obtaining, by a decoder, an original sample value of a current block. At step 2102, the method includes: determining, by the decoder, a slope adjustment for a model parameter in a compensation model based on a pre-determined range, wherein granularity of the slope adjustment is determined based on a refined sample value of a prediction block. At step 2103, the method includes: determining, by the decoder and based on the slope adjustment, an updated model parameter in the compensation model. At step 2104, the method includes: determining, by the decoder and based on the updated model parameter and the original sample value, a refined sample value or a second sample value of the current block.

In one or more embodiments, the pre-determined range of the slope adjustment is between −n to n, wherein n is an integer.

In one or more embodiments, n equals to 3 or 4.

In one or more embodiments, the granularity of the slope adjustment is 1/x^{th} of the refined sample value of the prediction block, wherein x is an integer.

In one or more embodiments, x equals to 8 or 16.

In one or more embodiments, a slope adjustment offset of the slope adjustment is equally distributed within the pre-determined range of the slope adjustment.

In one or more embodiments, the slope adjustment offset of the slope adjustment is symmetrically distributed around zero, with magnitudes increasing in powers oftwo away from zero.

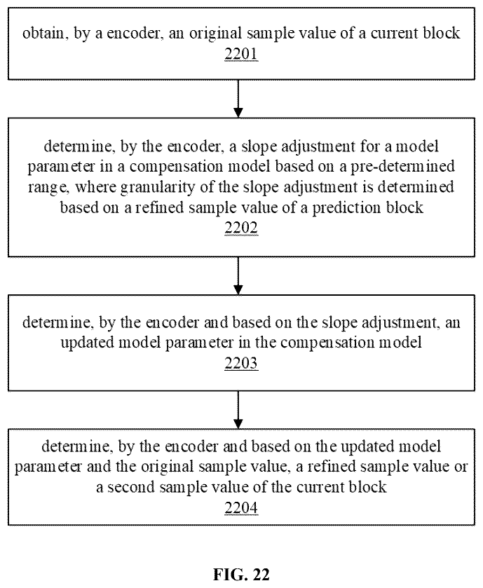

FIG. 22 is a flowchart illustrating a method for video encoding in accordance with some examples of the present disclosure. At step 2201, the method includes: obtaining, by an encoder, an original sample value of a current block. At step 2202, the method includes: determining, by the encoder, a slope adjustment for a model parameter in a compensation model based on a pre-determined range, wherein granularity of the slope adjustment is determined based on a refined sample value of a prediction block. At step 2203, the method includes: determining, by the encoder and based on the slope adjustment, an updated model parameter in the compensation model. At step 2204, the method includes: determining, by the encoder and based on the updated model parameter and the original sample value, a refined sample value or a second sample value of the current block.

In one or more embodiments, the pre-determined range of the slope adjustment is between −n to n, wherein n is an integer.

In one or more embodiments, n equals to 3 or 4.

In one or more embodiments, the granularity of the slope adjustment is 1/x^{th} of the refined sample value of the prediction block, wherein x is an integer.

In one or more embodiments, x equals to 8 or 16.

In one or more embodiments, a slope adjustment offset of the slope adjustment is equally distributed within the pre-determined range of the slope adjustment.

In one or more embodiments, the slope adjustment offset of the slope adjustment is symmetrically distributed around zero, with magnitudes increasing in powers oftwo away from zero.

In one or more embodiments, there is also provided a method of storing a bitstream, including storing the bitstream on a digital storage medium, wherein the bitstream includes encoded video information generated by the encoding method described above or encoded video information to be decoded by the decoding method described above.

In one or more embodiments, there is also provided a method for transmitting a bitstream generated by the encoder described above. In one or more embodiments, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, the scope of the disclosure is not to be limited to the specific examples of the implementations disclosed and that modifications and other implementations are intended to be included within the scope of the present disclosure.

What is claimed is:

1. A method for video decoding, comprising:
obtaining, by a decoder, an original sample value of a current block;
determining, by the decoder, a slope adjustment for a model parameter in a compensation model;
determining, by the decoder and based on the slope adjustment, an updated model parameter in the compensation model; and
determining, by the decoder and based on the updated model parameter and the original sample value, a refined sample value or a second sample value of the current block.

2. The method of claim 1, wherein the compensation model comprises at least one of the following models: an Intra Block Copy (IBC) Local Illumination Compensation (LIC) model, a filtered IBC model, a filtered Intra Template Matching Prediction (Intra TMP) model, a Convolutional Cross-Component Model (CCCM), or a Gradient Linear Model (GLM), or,
wherein the compensation model is a single model with an L-shape template or a multi-model with the L-shape template; or
wherein the compensation model is a single model with the L-shape template, or a single model with a left template, or a single model with a top template, or a multi-model with the L-shape template; or,
wherein a range of the slope adjustment is pre-determined, wherein a granularity of the slope adjustment is determined based on a refined sample value of a prediction block.

3. The method of claim 1, wherein the compensation model comprises an Intra Block Copy (IBC) Local Illumination Compensation (LIC) model, and the model parameter comprises a slope parameter and a bias parameter;
wherein determining the updated model parameter in the compensation model comprises:
determining, by the decoder and based on the slope adjustment, an updated slope parameter for the original sample value;
determining, by the decoder and based on the slope adjustment and a first adjustment, an updated bias parameter.

4. The method of claim 3, wherein determining the updated slope parameter for the original sample value comprises:
obtaining, by the decoder, the updated slope parameter for the original sample value by summing the slope adjustment and the slope parameter; and/or
wherein determining the updated bias parameter comprises:
obtaining, by the decoder, the updated bias parameter by calculating a difference between the bias parameter and a product of the slope adjustment and the first adjustment.

5. The method of claim 3, wherein the first adjustment comprises an average value of reference samples for the IBC LIC model.

6. The method of claim 1, wherein the compensation model comprises one of the following models: an Intra Block Copy (IBC) Local Illumination Compensation (LIC) model with IBC Advanced Motion Vector Prediction (AMVP) mode, a filtered IBC model with the IBC AMVP mode, or a filtered Intra Template Matching Prediction (Intra TMP) model, wherein the method further comprises:
receiving, by the decoder, a mode flag, wherein the mode flag is an IBC LIC flag, a filtered IBC flag, or a filtered Intra TMP flag;
in response to determining that the mode flag is true, receiving, by the decoder, a slope adjustment flag indicating whether the slope adjustment is applied; and
wherein determining the slope adjustment for the model parameter in the compensation model comprises:
in response to determining that the slope adjustment flag is true, receiving, by the decoder, the slope adjustment for the model parameter; or
wherein the compensation model comprises an Intra Block Copy (IBC) Local Illumination Compensation (LIC) model with IBC merge mode or a filtered IBC model with IBC merge mode, wherein the method further comprises:
determining, by the decoder, that the slope adjustment is disabled;
in response to determining that the slope adjustment is disabled, disabling, by the decoder, the slope adjustment for the model parameter; or
wherein the compensation model comprises an Intra Block Copy (IBC) Local Illumination Compensation (LIC) model with IBC merge mode or a filtered IBC model with IBC merge mode, wherein determining the slope adjustment for the model parameter in the compensation model comprises:
deriving, by the decoder, the slope adjustment for the model parameter from merge candidates; or
wherein the compensation model comprises an Intra Block Copy (IBC) Local Illumination Compensation (LIC) model with IBC merge mode or a filtered IBC model with IBC merge mode, wherein the method further comprises:
receiving, by the decoder, a flag indicating whether the slope adjustment is applied;
wherein determining the slope adjustment for the model parameter in the compensation model comprises:
in response to determining that the flag is false, obtaining, by the decoder, regular inheritance of the IBC LIC flag or the filtered IBC flag; and
in response to determining that the flag is true, obtaining, by the decoder, the slope adjustment in the IBC AMVP mode.

7. The method of claim 1, wherein the compensation model comprises an Intra Block Copy (IBC) Local Illumination Compensation (LIC) model with IBC merge mode or a filtered IBC model with IBC merge mode, wherein the method further comprises:
in response to determining that regular inheritance of the IBC LIC flag or the filtered IBC flag is disabled, receiving, by the decoder, a first flag indicating whether the IBC LIC model is applied or indicating whether the filtered IBC model is applied;
in response to determining that the first flag is true, receiving, by the decoder, a second flag indicating whether the slope adjustment for the model parameter is applied; and
wherein determining the slope adjustment for the model parameter in the compensation model comprises:
in response to determining that the second flag is true, receiving, by the decoder, the slope adjustment for the model parameter in IBC Advanced Motion Vector Prediction (AMVP) mode.

8. The method of claim 1, wherein the compensation model comprises one of the following models: a filtered IBC model, a filtered Intra Template Matching Prediction (Intra TMP) model, or a Convolutional Cross-Component Model (CCCM), and the model parameter comprises multiple convolution parameters;
wherein determining the updated model parameter in the compensation model comprises:
determining, by the decoder and based on the slope adjustment, a first updated convolution parameter of the multiple convolution parameters for the original sample value;
determining, by the decoder and based on the slope adjustment and a second adjustment, a second updated convolution parameter of the multiple convolution parameters for a scalar offset.

9. The method of claim 8, wherein determining the first updated convolution parameter for the original sample value comprises:
obtaining, by the decoder, the first updated convolution parameter for the original sample value by summing a corresponding slope adjustment of multiple slope adjustments and a corresponding parameter of the multiple convolution parameters.

10. The method of claim 8, wherein the second adjustment comprises at least one average sample value of reference samples for the compensation model;
wherein determining the second updated convolution parameter for the scalar offset comprises:
determining, by the decoder and based on at least one slope adjustment of multiple slope adjustments and the at least one average sample value of reference samples, the second updated convolution parameter for the scalar offset.

11. The method of claim 8, wherein determining the refined sample value or a second sample value of the current block comprises:
determining, by the decoder and based on the original sample value, the first updated convolution parameter, the scalar offset and the second updated convolution parameter, the refined sample value or a second sample value of the current block;
wherein the original sample value comprises a central sample value and additional plurality of sample values.

12. The method of claim 10, wherein the at least one average sample value of reference samples comprises at least one average sample value of central, north, south, east, west and the non-linear term of template reference samples.

13. The method of claim 11, wherein the compensation model comprises a Convolutional Cross-Component Model (CCCM), the method further comprising:
obtaining, by the decoder, an offset sample value for the original sample value;
determining, by the decoder and based on the offset sample value and the original sample value, an updated sample value;
wherein determining the refined sample value or a second sample value of the current block comprises:
determining, by the decoder and based on the updated sample value, the first updated convolution parameter, the scalar offset and the second updated convolution parameter, the refined sample value or a second sample value of the current block.

14. The method of claim 1, wherein the compensation model comprises a two-parameter GLM, wherein the original sample value is a luma sample gradient value of a luma reconstruction block and the second sample value is a predicted chroma sample value, wherein the model parameter comprises a slope parameter and a bias parameter;
wherein determining the updated model parameter in the compensation model comprises:
determining, by the decoder and based on the slope adjustment, an updated slope parameter for the luma sample gradient value;
determining, by the decoder and based on the slope adjustment and a third adjustment, an updated bias parameter;
wherein determining the refined sample value or the second sample value of the current block comprises:
determining, by the decoder and based on the luma sample gradient value, the updated slope parameter and the updated bias parameter, the predicted chroma sample value.

15. The method of claim 14, wherein the third adjustment comprises an average value of a luma sample gradient of reference samples for the two-parameter GLM.

16. The method of claim 1, wherein the compensation model comprises a three-parameter GLM, wherein the original sample value is a luma sample gradient value of a luma reconstruction block and the second sample value is a predicted chroma sample value, wherein the model parameter comprises at least one slope parameter;
wherein determining the updated model parameter in the compensation model comprises:
determining, by the decoder and based on the slope adjustment, a first updated slope parameter for the luma sample gradient value;
determining, by the decoder and based on the at least one slope parameter and a fourth adjustment, a second updated slope parameter for a scalar offset;
wherein determining the refined sample value or the second sample value of the current block comprises:
determining, by the decoder and based on the luma sample gradient value, the first updated slope parameter, the scalar offset, the second updated slope parameter, a down-sampled luma sample value and a third slope parameter, the predicted chroma sample value.

17. The method of claim 16, the method further comprising:
determining, by the decoder and based on the slope adjustment, a third updated slope parameter for the down-sampled luma sample value in a corresponding luma reconstruction block;
wherein determining the refined sample value or the second sample value of the current block comprises:
determining, by the decoder and based on the luma sample gradient value, the first updated slope parameter, the scalar offset, the second updated slope parameter, the down-sampled luma sample value and the third updated slope parameter, the predicted chroma sample value.

18. The method of claim 16, wherein the fourth adjustment comprises an average value of a luma sample gradient of reference samples for the three-parameter GLM and/or an average value of a down-sampled luma sample value of reference samples for the three-parameter GLM.

19. An apparatus for video coding, comprising:
one or more processors; and
a memory coupled to the one or more processors and configured to store instructions executable by the one or more processors,
wherein the one or more processors, upon execution of the instructions, are configured to perform operations comprising:
obtaining an original sample value of a current block;
determining a slope adjustment for a model parameter in a compensation model;
determining based on the slope adjustment, an updated model parameter in the compensation model; and
determining based on the updated model parameter and the original sample value, a refined sample value or a second sample value of the current block.

20. A non-transitory computer-readable storage medium storing a bitstream formed by instructions which when executed by a computing device having one or more processors, cause the one or more processors to perform an encoding method comprising:
obtaining an original sample value of a current block;
determining a slope adjustment for a model parameter in a compensation model;
determining based on the slope adjustment, an updated model parameter in the compensation model; and
determining based on the updated model parameter and the original sample value, a refined sample value or a second sample value of the current block.
